(19) United States
(12) Patent Application Publication
(10) Pub. No.: US 2026/0084412 A1
(43) Pub. Date: Mar. 26, 2026

(54) LIQUID DISCHARGE APPARATUS AND PRINT HEAD DRIVE CIRCUIT

(71) Applicant: SEIKO EPSON CORPORATION, Tokyo (JP)

(72) Inventors: Tomonori YAMADA, Shiojiri (JP); Toru MATSUYAMA, Matsumoto (JP)

(21) Appl. No.: 19/335,022

(22) Filed: Sep. 22, 2025

(30) Foreign Application Priority Data
Sep. 24, 2024 (JP) 2024-165016

(51) Int. Cl. B41J 2/045; B41J 2/14

(52) U.S. Cl. CPC B41J 2/04541; B41J 2/0455; B41J 2/04581; B41J 2/04588; B41J 2/14233

(57) ABSTRACT

A liquid discharge apparatus, in which a first transistor included in an amplification circuit that outputs an amplification modulation signal obtained by amplifying a modulation signal, which is included in a print head drive circuit, includes a first conductor, a second conductor, a third conductor, a first layer that includes a first semiconductor region and a second semiconductor region, and a second layer that includes a third semiconductor region, a fourth semiconductor region provided in the third semiconductor region, and a fifth semiconductor region provided in the fourth semiconductor region, the first layer is disposed above the third conductor, the second layer is disposed above the first layer, the first conductor is disposed above the fourth semiconductor region, and the second conductor is disposed above the fifth semiconductor region.

The present application is based on, and claims priority from JP Application Serial Number 2024-165016, filed Sep. 24, 2024, the disclosure of which is hereby incorporated by reference herein in its entirety.

### BACKGROUND

### 1. Technical Field

The present disclosure relates to a liquid discharge apparatus and a print head drive circuit.

### 2. Related Art

A liquid discharge apparatus such as an ink jet printer includes a print head that discharges a liquid, and a print head drive circuit that controls the print head, the print head drive circuit outputs a drive signal that drives a drive element such as a piezoelectric element provided in the print head, and the print head discharges ink by the driving of the drive element. The liquid discharge apparatus forms an image at a medium by landing the ink discharged from the print head at a desired position on the medium.

For example, JP-A-2015-164779 discloses a liquid discharge apparatus including a head drive circuit that outputs a drive signal and a print head unit that discharges ink in response to the drive signal.

In recent years, in response to a market demand for productivity improvement in liquid discharge apparatuses, improvement in an image formation speed on media is required for the liquid discharge apparatuses. Therefore, print head drive circuits that drive printer heads that discharge a liquid are required to output drive signals that enable a large number of drive elements to be driven at a higher frequency. However, the technique described in JP-A-2015-164779 is not satisfactory from the viewpoint of outputting drive signals that enable a large number of drive elements to be driven at a higher frequency, and there is room for improvement.

### SUMMARY

According to an aspect of the present disclosure, there is provided a liquid discharge apparatus including: a print head that discharges a liquid in response to a drive signal; and a print head drive circuit that outputs the drive signal, in which the print head drive circuit includes a modulation circuit that outputs a modulation signal obtained by modulating a basic drive signal that serves as a base of the drive signal, an amplification circuit that outputs an amplification modulation signal obtained by amplifying the modulation signal with a first transistor and a second transistor, and a demodulation circuit that demodulates the amplification modulation signal and outputs the demodulated signal as the drive signal, the first transistor includes a first conductor that functions as a source electrode, a second conductor that functions as a gate electrode, a third conductor that functions as a drain electrode, a first layer that includes a first semiconductor region of a first conductive type having a trench and a second semiconductor region of a second conductive type provided in the trench, and a second layer that includes a third semiconductor region of the first conductive type, a fourth semiconductor region of the second conductive type provided in the third semiconductor region, and a fifth semiconductor region of the first conductive type provided in the fourth semiconductor region, the first layer is disposed above the third conductor, the second layer is disposed above the first layer, the first conductor is disposed above the fourth semiconductor region, and the second conductor is disposed above the fifth semiconductor region.

According to an aspect of the present disclosure, there is provided a print head drive circuit that outputs a drive signal to a print head that discharges a liquid in response to the drive signal, the print head drive circuit including: a modulation circuit that outputs a modulation signal obtained by modulating a basic drive signal that serves as a base of the drive signal; an amplification circuit that outputs an amplification modulation signal obtained by amplifying the modulation signal with a first transistor and a second transistor; and a demodulation circuit that demodulates the amplification modulation signal and outputs the demodulated signal as the drive signal, in which the first transistor includes a first conductor that functions as a source electrode, a second conductor that functions as a gate electrode, a third conductor that functions as a drain electrode, a first layer that includes a first semiconductor region of a first conductive type having a trench and a second semiconductor region of a second conductive type provided in the trench, and a second layer that includes a third semiconductor region of the first conductive type, a fourth semiconductor region of the second conductive type provided in the third semiconductor region, and a fifth semiconductor region of the first conductive type provided in the fourth semiconductor region, the first layer is disposed above the third conductor, the second layer is disposed above the first layer, the first conductor is disposed above the fourth semiconductor region, and the second conductor is disposed above the fifth semiconductor region.

### BRIEF DESCRIPTION OF THE DRAWINGS

FIG. 1 is a diagram illustrating an example of a schematic configuration of a liquid discharge apparatus.

FIG. 2 is a diagram illustrating an example of a functional configuration of the liquid discharge apparatus.

FIG. 3 is a diagram illustrating a schematic structure of a discharge section.

FIG. 4 is a diagram illustrating an example of signal waveforms of drive signals.

FIG. 5 is a diagram illustrating an example of a configuration of a selection control circuit and a selection circuit.

FIG. 6 is a diagram illustrating an example of decoding contents in a decoder.

FIG. 7 is a diagram illustrating an example of a configuration of the selection circuit.

FIG. 8 is a diagram for describing operations of the selection control circuit and the selection circuit.

FIG. 9 is a diagram illustrating an example of a configuration of a drive circuit.

FIG. 10 is a diagram illustrating an example of a structure of a transistor.

### DESCRIPTION OF EMBODIMENTS

Hereinafter, appropriate embodiments of the present disclosure will be described with reference to the drawings. The drawings to be used are for convenience of description. In addition, embodiments to be described below do not inappropriately limit the contents of the present disclosure described in the claims. Moreover, not all of configurations to be described below are necessarily essential components of the present disclosure.

### 1. Overview of Liquid Discharge Apparatus

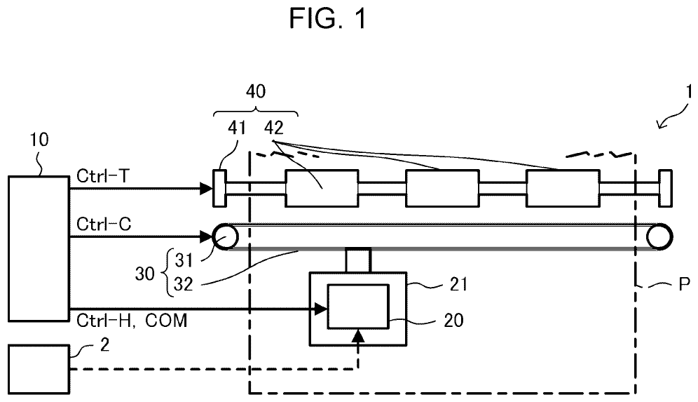

FIG. 1 is a diagram illustrating an example of a schematic configuration of a liquid discharge apparatus 1. The liquid discharge apparatus 1 is a serial printing-type ink jet printer in which a carriage 21 on which a print head 20 that discharges ink as an example of a liquid is mounted reciprocates along a scanning axis and discharges ink to a medium P that is transported along a transport direction to form a desired image on the medium P. As the medium P that is used in such a liquid discharge apparatus 1, any printing target such as a printing paper, a resin film, or a cloth can be used. The liquid discharge apparatus 1 is not limited to the serial printing-type ink jet printer, and may be a line printing-type ink jet printer. In addition, the liquid discharge apparatus 1 is not limited to an ink jet printer, and may be a coloring material discharge apparatus used for manufacturing a color filter such as a liquid crystal display, an electrode material discharge apparatus used for forming an electrode such as an organic EL display or a field emission display (FED), a bioorganic substance discharge apparatus used for manufacturing a biochip, a stereolithography apparatus, a textile printing apparatus, and the like.

As illustrated in FIG. 1, the liquid discharge apparatus 1 includes an ink container 2, a control unit 10, the print head 20, a moving unit 30, and a transport unit 40.

A plurality of types of ink to be discharged to the medium P are stored in the ink container 2. Examples of the colors of the ink stored in the ink container 2 include black, cyan, magenta, yellow, red, and gray. As the ink container 2 in which such ink is stored, an ink cartridge, a bag-shaped ink pack formed of a flexible film, an ink tank into which ink can be replenished, and the like can be used.

The control unit 10 includes, for example, a processing circuit such as a central processing unit (CPU) or a field programmable gate array (FPGA), a storage circuit such as a semiconductor memory, and various other circuits, and controls each element of the liquid discharge apparatus 1 including the print head 20.

The print head 20 is mounted on the carriage 21. In addition, the carriage 21 is fixed to an endless belt 32 that is included in the moving unit 30. In addition to the print head 20, the carriage 21 may be mounted on the ink container 2.

A control signal Ctrl-H for controlling the print head 20 output by the control unit 10 and a drive signal COM are input to the print head 20 mounted on the carriage 21. In addition, the ink stored in the ink container 2 is supplied to the print head 20 via a tube (not illustrated). The print head 20 discharges the ink that is supplied from the ink container 2 based on the input control signal Ctrl-H and drive signal COM.

The moving unit 30 includes a carriage motor 31 and the endless belt 32. The carriage motor 31 drives the moving unit 30 based on the control signal Ctrl-C that is input from the control unit 10. The endless belt 32 rotates in accordance with the driving of the carriage motor 31. As a result, the carriage 21 fixed to the endless belt 32 reciprocates along the scanning axis. That is, the print head 20 mounted on the carriage 21 reciprocates along the scanning axis intersecting with the transport direction in which the medium P is transported.

The transport unit 40 includes a transport motor 41 and transport rollers 42. The transport motor 41 is driven based on the control signal Ctrl-T that is input from the control unit 10. The transport rollers 42 rotate in accordance with the driving of the transport motor 41. The medium P is transported in the transport direction in accordance with the rotation of the transport rollers 42.

In the liquid discharge apparatus 1 configured as described above, in conjunction with the transport of the medium P by the transport unit 40 and the reciprocating motion of the carriage 21 by the moving unit 30, the print head 20 mounted on the carriage 21 discharges the ink to the medium P. As a result, the ink that is discharged from the print head 20 lands on any position on the surface of the medium P. As a result, a desired image is formed at the medium P.

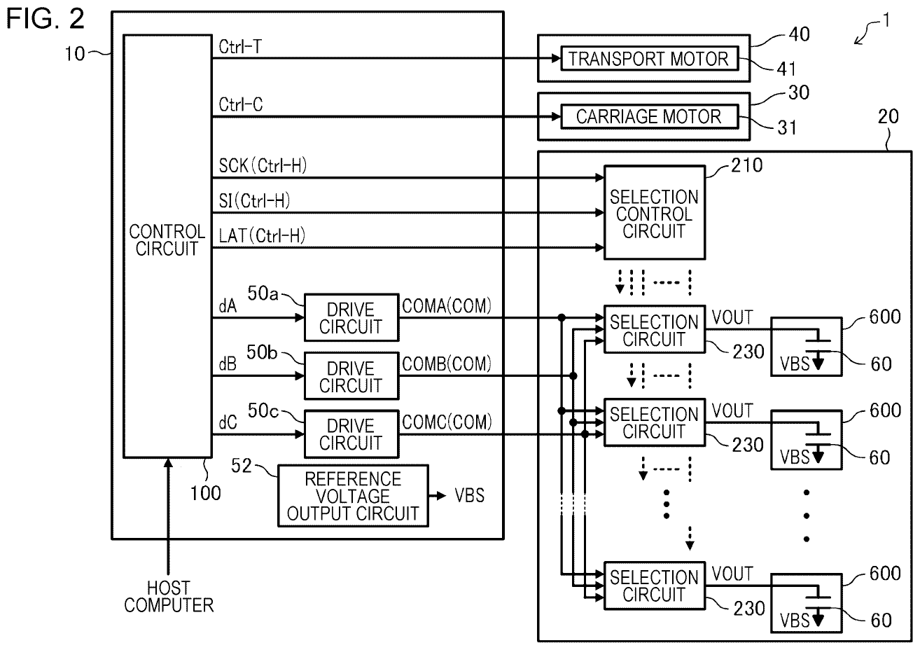

A specific example of the functional configuration of the liquid discharge apparatus 1 configured as described above will be described. FIG. 2 is a diagram illustrating an example of the functional configuration of the liquid discharge apparatus 1. As illustrated in FIG. 2, the liquid discharge apparatus 1 includes the control unit 10, the print head 20, the moving unit 30, and the transport unit 40.

The control unit 10 includes a control circuit 100, drive circuits 50a, 50b, and 50c, and a reference voltage output circuit 52.

When an image signal is input from an external device such as a host computer, the control circuit 100 generates various control signals in response to the image signal and outputs the generated control signals to the corresponding configurations.

Specifically, when an image signal is input, and a printing process is executed on the medium P, the control circuit 100 generates the control signal Ctrl-T and the control signal Ctrl-C. The control signal Ctrl-T output by the control circuit 100 is input to the transport motor 41 included in the transport unit 40. The transport motor 41 is driven according to the control signal Ctrl-T. The medium P is transported along the transport direction by the driving force of the transport motor 41. In addition, the control signal Ctrl-C output by the control circuit 100 is input to the carriage motor 31 included in the moving unit 30. The carriage motor 31 is driven according to the control signal Ctrl-C. The carriage 21 on which the print head 20 is mounted reciprocates along the scanning axis by the driving force of the carriage motor 31. The transport unit 40 may include one or a plurality of transport rotors in addition to the transport motor 41. In addition, the transport unit 40 may include a transport motor driver circuit for converting the control signal Ctrl-T into a predetermined signal for driving the transport motor 41. In addition, the moving unit 30 may include a carriage motor driver circuit for converting the control signal Ctrl-C into a predetermined signal for driving the carriage motor 31.

In addition, the control circuit 100 generates digital basic drive signals dA, dB, and dC and outputs the digital basic drive signals dA, dB, and dC to the corresponding drive circuits 50a, 50b, and 50c.

The basic drive signal dA is input to the drive circuit 50a. The drive circuit 50a performs digital/analog conversion on the input basic drive signal dA and performs D-class amplification on the converted analog signal, thereby generating a drive signal COMA as the drive signal COM and outputting the drive signal COMA to the print head 20. The basic drive signal dB is input to the drive circuit 50b. The drive circuit 50b performs digital/analog conversion on the input basic drive signal dB and performs D-class amplification on the converted analog signal, thereby generating a drive signal COMB as the drive signal COM and outputting the drive signal COMB to the print head 20. The basic drive signal dC is input to the drive circuit 50c. The drive circuit 50c performs digital/analog conversion on the input basic drive signal dC and performs D-class amplification on the converted analog signal, thereby generating a drive signal COMC as the drive signal COM and outputting the drive signal COMC to the print head 20.

That is, the control circuit 100 outputs the basic drive signals dA, dB, and dC that serve as the bases of the drive signals COMA, COMB, and COMC as the drive signal COM, and the drive circuits 50a, 50b, and 50c perform D-class amplification on the signals having signal waveforms defined by the input basic drive signals dA, dB, and dC, thereby generating the drive signals COMA, COMB, and COMC and outputting the drive signals to the print head 20.

The reference voltage output circuit 52 generates a reference voltage signal VBS that is a constant DC voltage at a voltage value of 5.5 V, 6 V, or the like, and outputs the reference voltage signal VBS to the print head 20. The reference voltage signal VBS functions as a reference potential for driving a piezoelectric element 60 (to be described below) of the print head 20. The potential of the reference voltage signal VBS is not limited to 5.5 V and 6 V, and may be a ground potential.

In addition, the control circuit 100 generates a clock signal SCK, a print data signal SI, and a latch signal LAT as the control signal Ctrl-H based on the image signal input from the external device, and outputs the generated signals to the print head 20.

The print head 20 includes a selection control circuit 210, a plurality of selection circuits 230, and a plurality of discharge sections 600. The plurality of discharge sections 600 are provided to correspond to the plurality of selection circuits 230, respectively.

The clock signal SCK, the print data signal SI, and the latch signal LAT are input to the selection control circuit 210 as the control signal Ctrl-H. The selection control circuit 210 generates a selection signal S corresponding to each of the plurality of selection circuits 230 based on the input clock signal SCK, print data signal SI, and latch signal LAT, and outputs the selection signal S to the corresponding selection circuit 230.

The drive signals COMA, COMB, and COMC as the drive signal COM and the corresponding selection signals S output by the selection control circuit 210 are input to each selection circuit 230. The selection circuit 230 selects or deselects each of the drive signals COMA, COMB, and COMC based on the input selection signal S, thereby generating a drive signal VOUT and supplying the generated drive signal VOUT to the corresponding discharge section 600.

Each of the plurality of discharge sections 600 includes the piezoelectric element 60. The drive signal VOUT output by the corresponding selection circuit 230 is supplied to one end of the piezoelectric element 60 included in each of the plurality of discharge sections 600. In addition, the reference voltage signal VBS output by the reference voltage output circuit 52 is commonly supplied to the other end of the piezoelectric element 60 included in each of the plurality of discharge sections 600. In addition, the piezoelectric element 60 is driven according to a potential difference between the drive signal VOUT supplied to one end and the reference voltage signal VBS supplied to the other end. The ink is discharged from the discharge section 600 in an amount corresponding to the driving of the piezoelectric element 60.

That is, the liquid discharge apparatus 1 includes the print head 20 that discharges the ink in response to the drive signal COM, and the drive circuit 50 included in the control unit 10 that outputs the drive signal COM to the print head 20. In other words, the drive circuit 50 included in the control unit 10 outputs the drive signal COM to the print head 20 that discharges the ink in response to the drive signal COM.

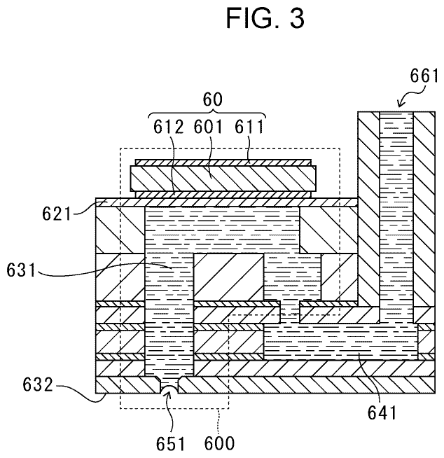

Here, an example of the structure of the discharge section 600 included in the print head 20 will be described. FIG. 3 is a diagram illustrating a schematic structure of one of the plurality of discharge sections 600 included in the print head 20. As illustrated in FIG. 3, the discharge section 600 includes the piezoelectric element 60, a vibrating plate 621, a cavity 631, and a nozzle 651.

The cavity 631 is filled with the ink supplied from a reservoir 641. In addition, the ink is introduced into the reservoir 641 from the ink container 2 via an ink tube (not illustrated) and a supply port 661. That is, the cavity 631 is filled with the ink that is stored in the corresponding ink container 2.

The vibrating plate 621 is displaced by the driving of the piezoelectric element 60 provided on the upper surface in FIG. 3. In addition, the internal volume of the cavity 631 filled with the ink is expanded and reduced in association with the displacement of the vibrating plate 621. That is, the vibrating plate 621 functions as a diaphragm that changes the internal volume of the cavity 631.

The nozzle 651 is an opening which is provided on a nozzle plate 632 and communicates with the cavity 631. When the internal volume of the cavity 631 changes, the ink is discharged from the nozzle 651 in an amount corresponding to the change in internal volume.

The piezoelectric element 60 has a structure in which a piezoelectric body 601 is interposed between a pair of electrodes 611 and 612. In the piezoelectric body 601 having such a structure, the central portions of the electrodes 611 and 612 bend in the vertical direction together with the vibrating plate 621 according to the potential difference of the signals supplied to the electrodes 611 and 612.

For example, the drive signal VOUT is supplied to one end of the piezoelectric element 60 and one of the electrode 611 or the electrode 612, and the reference voltage signal VBS is supplied to the other end of the piezoelectric element 60 and the other of the electrode 611 or the electrode 612. When the voltage value of the drive signal VOUT becomes high, the piezoelectric element 60 bends in the upward direction. In addition, the piezoelectric element 60 bends in the upward direction, whereby the vibrating plate 621 is displaced, and the internal volume of the cavity 631 is expanded. As a result, the ink is drawn from the reservoir 641. On the other hand, when the voltage value of the drive signal VOUT becomes low, the piezoelectric element 60 bends in the downward direction. In addition, the piezoelectric element 60 bends in the downward direction, whereby the vibrating plate 621 is displaced, and the internal volume of the cavity 631 is reduced. As a result, the ink is discharged from the nozzle 651 in an amount corresponding to the degree of reduction.

That is, the discharge section 600 includes the piezoelectric element 60 that is driven by the drive signal VOUT based on the drive signal COM, and discharges the ink by the driving of the piezoelectric element 60. In other words, the print head 20 discharges the ink in response to the drive signals COMA, COMB, and COMC.

Here, in the liquid discharge apparatus 1 of the present embodiment, from the viewpoint of improving the image formation speed on the medium P, that is, improving the productivity in the liquid discharge apparatus 1, a case where the print head 20 has 3,000 or more discharge sections 600 and the drive circuits 50a, 50b, and 50c supply the drive signals COMA, COMB, and COMC to 3,000 or more discharge sections 600 is assumed. That is, a case where the print head 20 has 3,000 or more piezoelectric elements 60 and the drive circuits 50a, 50b, and 50c supply the drive signals COMA, COMB, and COMC to 3,000 or more piezoelectric elements 60 is assumed. As a result, the number of dots that can be formed at the medium P at once, which is the amount of the ink that can be discharged at once, increases, and improvement in the image formation speed on the medium P, that is, improvement in the productivity in the liquid discharge apparatus 1, can be achieved. That is, the print head 20 includes 3,000 or more piezoelectric elements 60, and the 3,000 or more piezoelectric elements 60 are driven by the drive signal COM output by the drive circuit 50.

The structure of the piezoelectric element 60 is not limited to one example illustrated in FIG. 3, and may be a structure in which the ink can be discharged from the discharge section 600. Therefore, the structure of the piezoelectric element 60 is not limited to the above-described bending vibration structure, and may be, for example, a structure in which longitudinal vibration is used. In addition, the piezoelectric element 60 may be configured to bend in the downward direction when the voltage value of the drive signal VOUT becomes high and to bend in the upward direction when the voltage value of the drive signal VOUT becomes low.

### 2. Signal Waveform of Drive Signal

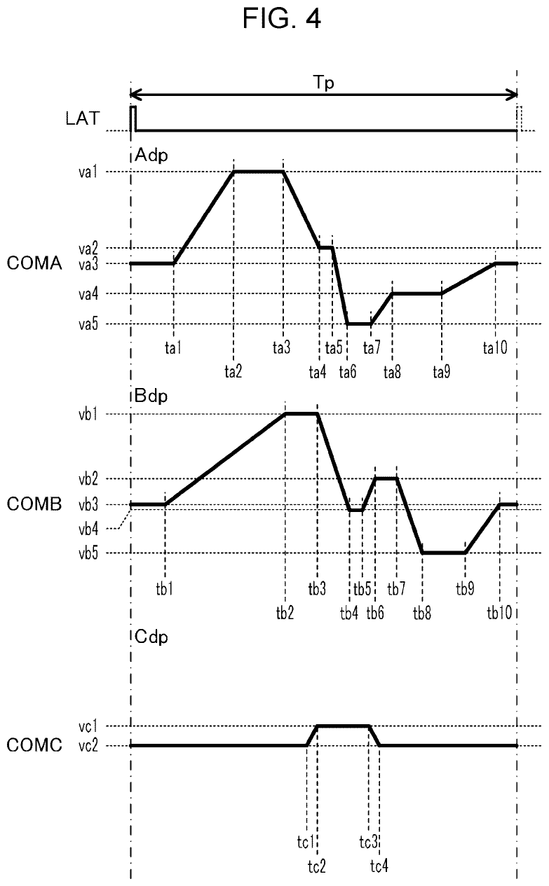

Next, an example of the signal waveform of each of the drive signals COMA, COMB, and COMC output by the drive circuits 50a, 50b, and 50c will be described. FIG. 4 is a diagram illustrating an example of the signal waveforms of the drive signals COMA, COMB, and COMC. As illustrated in FIG. 4, the drive signals COMA, COMB, and COMC include drive waveforms Adp, Bdp, and Cdp disposed in a period tp from the rise of the latch signal LAT to the next rise of the latch signal LAT, respectively. In addition, the selection control circuit 210 and the selection circuit 230 select any of the drive signals COMA, COMB, and COMC, which is any of the drive waveforms Adp, Bdp, and Cdp, based on the clock signal SCK and the print data signal SI every period tp, and output the selected drive signal as the drive signal VOUT.

As illustrated in FIG. 4, in the drive waveform Adp, the voltage value changes between a voltage va1 and a voltage va5 during the period tp, whereby the corresponding piezoelectric element 60 is driven. A predetermined amount of the ink is discharged from the corresponding nozzle 651 by the driving of the piezoelectric element 60. That is, the drive waveform Adp included in the drive signal COMA is a signal waveform for driving the corresponding piezoelectric element 60 such that a predetermined amount of the ink is discharged from the discharge section 600. Here, in the following description, it is assumed that the voltage va1 is 36 V, the voltage va2 is 15 V, the voltage va3 is 12 V, the voltage va4 is 8 V, and the voltage va5 is 5 V, but the values of the voltage va1 to the voltage va5 are not limited thereto.

Specifically, at the timing of the rise of the latch signal LAT and the timing of the start of the period tp, the voltage value of the drive waveform Adp is constant at the voltage va3. Thereafter, the voltage value of the drive waveform Adp starts to increase at a time ta1 and becomes constant at the voltage va1 at a time ta2. In addition, the voltage value of the drive waveform Adp starts to decrease at a time ta3, becomes constant at the voltage va2 at a time ta4, then, starts to decrease again at a time ta5, and becomes constant at the voltage va5 at a time ta6. Thereafter, the voltage value of the drive waveform Adp starts to increase at a time ta7, becomes constant at the voltage va4 at a time ta8, then, starts to increase again at a time ta9, and becomes constant at the voltage va3 at a time ta10. Thereafter, the latch signal LAT rises, whereby the period tp ends.

In the discharge section 600 to which the drive waveform Adp as described above is supplied, the ink that is stored in the ink container 2 is supplied to the cavity 631 via the supply port 661 at the timing of the rise of the latch signal LAT. At this time, the position of the tip portion of the ink stored inside the nozzle 651 included in the discharge section 600, which is the position of a meniscus in the nozzle 651, is substantially the same as the position of the tip of the nozzle 651. In addition, when the voltage value of the drive waveform Adp increases at the time ta1, in the discharge section 600 to which the drive waveform Adp is supplied, the piezoelectric element 60 bends in the upward direction illustrated in FIG. 3, and the internal volume of the cavity 631 increases. As a result, the ink stored inside the nozzle 651 included in the discharge section 600 is drawn into the cavity 631, and the position of the meniscus in the nozzle 651 moves in the upward direction illustrated in FIG. 3.

Thereafter, at the time ta2, the voltage value of the drive waveform Adp becomes constant, whereby the position of the meniscus in the nozzle 651 included in the discharge section 600 is maintained, and then, at the time ta3, when the voltage value of the drive waveform Adp decreases, in the discharge section 600 to which the drive waveform Adp is supplied, the piezoelectric element 60 bends in the downward direction illustrated in FIG. 3 and the internal volume of the cavity 631 decreases. As a result, the ink stored in the cavity 631 is pressurized and moves toward the corresponding nozzle 651. At this time, the central portion of the meniscus formed by the ink stored inside the nozzle 651 is pushed out, and a liquid column stretching downward as illustrated in FIG. 3 is formed.

At the time ta4, when the voltage value of the drive waveform Adp becomes constant, the liquid column formed at the central portion of the meniscus tends to stretch in the downward direction illustrated in FIG. 3 by the inertial force. In addition, at the time ta5, the voltage value of the drive waveform Adp decreases, and the internal volume of the cavity 631 decreases, whereby the ink stored in the cavity 631 is pressurized. As a result, the ink is separated from the liquid column and is discharged as droplets.

Thereafter, at the time ta6, the voltage value of the drive waveform Adp becomes constant, and at the time ta7 to the time ta10, the voltage value of the drive waveform Adp increases and becomes constant at the voltage va3. As a result, the displacement of the piezoelectric element 60 included in the discharge section 600 to which the drive waveform Adp is supplied and the internal volume of the cavity 631 fall into the state where the latch signal LAT rises. At this time, an amount of ink corresponding to the amount of the discharged ink is supplied from the ink container 2 to the cavity 631 via the supply port 661 by the capillary phenomenon. As a result, the position of the meniscus in the nozzle 651 of the discharge section 600 at the timing of the rise of the latch signal LAT becomes a position substantially the same as the position of the tip of the nozzle 651.

In addition, as illustrated in FIG. 4, in the drive waveform Bdp, the voltage value changes between a voltage vb1 and a voltage vb5 during the period tp, whereby the corresponding piezoelectric element 60 is driven. The ink is discharged from the corresponding nozzle 651 in an amount smaller than the above-described predetermined amount by the driving of the piezoelectric element 60. That is, the drive waveform Bdp included in the drive signal COMB is a signal waveform for driving the corresponding piezoelectric element 60 such that the ink is discharged from the discharge section 600 in an amount smaller than the above-described predetermined amount. Here, in the following description, it is assumed that the voltage vb1 is 36 V, the voltage vb2 is 20 V, the voltage vb3 is 12 V, the voltage vb4 is 10 V, and the voltage vb5 is 7 V, but the values of the voltage vb1 to the voltage vb5 are not limited thereto. Specifically, at the timing of the rise of the latch signal LAT and the timing of the start of the period tp, the voltage value of the drive waveform Bdp is constant at the voltage vb3. Thereafter, the voltage value of the drive waveform Bdp starts to increase at a time tb1 and becomes constant at the voltage vb1 at a time tb2. In addition, the voltage value of the drive waveform Bdp starts to decrease at a time tb3, becomes constant at the voltage vb4 at a time tb4, then, starts to increase at a time tb5, becomes constant at the voltage vb2 at a time tb6, then, starts to decrease at a time tb7, and becomes constant at the voltage vb5 at a time tb8. In addition, the voltage value of the drive waveform Bdp starts to increase at a time tb9 and becomes constant at the voltage vb3 at a time tb10. Thereafter, the latch signal LAT rises, whereby the period tp ends.

In the discharge section 600 to which the drive waveform Bdp as described above is supplied, the ink that is stored in the ink container 2 is supplied to the cavity 631 via the supply port 661 at the timing of the rise of the latch signal LAT. At this time, the position of the tip portion of the ink stored inside the nozzle 651 included in the discharge section 600, which is the position of a meniscus in the nozzle 651, is substantially the same as the position of the tip of the nozzle 651. In addition, when the voltage value of the drive waveform Bdp increases at the time tb1, in the discharge section 600 to which the drive waveform Bdp is supplied, the piezoelectric element 60 bends in the upward direction illustrated in FIG. 3, and the internal volume of the cavity 631 increases. As a result, the ink stored inside the nozzle 651 included in the discharge section 600 is drawn into the cavity 631, and the position of the meniscus in the nozzle 651 moves in the upward direction illustrated in FIG. 3.

Thereafter, at the time tb2, the voltage value of the drive waveform Bdp becomes constant, whereby the position of the meniscus in the nozzle 651 included in the discharge section 600 is maintained, and then, at the time tb3, when the voltage value of the drive waveform Bdp decreases, in the discharge section 600 to which the drive waveform Bdp is supplied, the piezoelectric element 60 bends in the downward direction illustrated in FIG. 3 and the internal volume of the cavity 631 decreases. As a result, the ink stored in the cavity 631 is pressurized and moves toward the corresponding nozzle 651. At this time, the central portion of the meniscus formed by the ink stored inside the nozzle 651 is pushed out, and a liquid column stretching downward as illustrated in FIG. 3 is formed.

At the time tb4, when the voltage value of the drive waveform Bdp becomes constant, the liquid column formed at the central portion of the meniscus tends to stretch in the downward direction illustrated in FIG. 3 by the inertial force. In addition, at the time tb5, when the voltage value of the drive waveform Bdp increases, and the internal volume of the cavity 631 increases, the liquid column that tends to stretch in the downward direction illustrated in FIG. 3 is drawn by the inertial force. At the time tb6 thereafter, the voltage value of the drive waveform Bdp becomes constant, and the voltage value of the drive waveform Bdp then decreases at the time tb7, whereby the internal volume of the cavity 631 decreases, the ink stored in the cavity 631 is pressurized, and the ink is separated from the liquid column, and is discharged as droplets. At this time, at the time tb5, the liquid column that tends to stretch in the downward direction illustrated in FIG. 3 is drawn by the inertial force, and the droplets from which the ink pressurized and separated from the liquid column is separated is discharged at the time tb7, whereby the discharge amount of the ink that is discharged from the discharge section 600 to which the drive waveform Bdp is supplied becomes smaller than the discharge amount of the ink that is discharged from the discharge section 600 to which the drive waveform Adp is supplied.

Thereafter, at the time tb8, the voltage value of the drive waveform Bdp becomes constant, and at the times tb9 and tb10, the voltage value of the drive waveform Bdp increases and becomes constant at the voltage vb3. As a result, the displacement of the piezoelectric element 60 included in the discharge section 600 to which the drive waveform Bdp is supplied and the internal volume of the cavity 631 fall into the state where the latch signal LAT rises. At this time, an amount of ink corresponding to the amount of the discharged ink is supplied from the ink container 2 to the cavity 631 via the supply port 661 by the capillary phenomenon. As a result, the position of the meniscus in the nozzle 651 of the discharge section 600 at the timing of the rise of the latch signal LAT becomes a position substantially the same as the position of the tip of the nozzle 651.

In addition, as illustrated in FIG. 4, in the drive waveform Cdp, the voltage value changes between a voltage vc1 and a voltage vc2 during the period tp, whereby the corresponding piezoelectric element 60 is driven. The ink is not discharged from the corresponding nozzle 651 by the driving of the piezoelectric element 60, and the ink in the vicinity of the opening portion of the nozzle 651 vibrates. As a result, a possibility of an increase in the viscosity of the ink in the vicinity of the opening portion of the nozzle 651 is reduced. That is, the drive waveform Cdp included in the drive signal COMC is a signal waveform for driving the piezoelectric element 60 such that the ink is not discharged from the discharge section 600, and the ink in the vicinity of the opening portion of the nozzle 651 included in the discharge section 600 vibrates. Here, in the following description, it is assumed that the voltage vc1 is 15 V, and the voltage vc2 is 12 V, but the values of the voltage vc1 and the voltage vc2 are not limited thereto.

Specifically, at the timing of the rise of the latch signal LAT and the timing of the start of the period tp, the voltage value of the drive waveform Cdp is constant at the voltage vc2. Thereafter, the voltage value of the drive waveform Cdp starts to increase at a time tc1 and becomes constant at the voltage vc1 at a time tc2. In addition, the voltage value of the drive waveform Cdp starts to decrease at a time tc3 and becomes constant at the voltage vc2 at a time tc4. Thereafter, the latch signal LAT rises, whereby the period tp ends.

In the discharge section 600 to which the drive waveform Cdp as described above is supplied, the ink that is stored in the ink container 2 is supplied to the cavity 631 via the supply port 661 at the timing of the rise of the latch signal LAT. At this time, the position of the tip portion of the ink stored inside the nozzle 651 included in the discharge section 600, which is the position of a meniscus in the nozzle 651, is substantially the same as the position of the tip of the nozzle 651. In addition, when the voltage value of the drive waveform Cdp increases at the time tc1, in the discharge section 600 to which the drive waveform Cdp is supplied, the piezoelectric element 60 bends in the upward direction illustrated in FIG. 3, and the internal volume of the cavity 631 increases. As a result, the ink stored inside the nozzle 651 included in the discharge section 600 is drawn into the cavity 631, and the position of the meniscus in the nozzle 651 moves in the upward direction illustrated in FIG. 3. Thereafter, at the time tc2, the voltage value of the drive waveform Bdp becomes constant, whereby the position of the meniscus in the nozzle 651 included in the discharge section 600 is maintained, and then, at the time tc3, when the voltage value of the drive waveform Cdp decreases, in the discharge section 600 to which the drive waveform Cdp is supplied, the piezoelectric element 60 bends in the downward direction illustrated in FIG. 3 and the internal volume of the cavity 631 decreases. As a result, the ink stored in the cavity 631 is pressurized and moves toward the corresponding nozzle 651. At this time, the central portion of the meniscus formed by the ink stored inside the nozzle 651 is pushed out, and a liquid column stretching downward as illustrated in FIG. 3 is formed. Thereafter, at the time tc4, the voltage value of the drive waveform Bdp becomes constant. At this time, the change in the voltage value of the drive waveform Cdp is smaller than the change in the voltage value of the drive waveform Adp and the change in the voltage value of the drive waveform Bdp, and the ink is thus not separated from the liquid column. Therefore, the ink simply vibrates from the nozzle 651 but is not discharged.

In addition, at the time tc4, the voltage value of the drive waveform Cdp is constant at the voltage vc2, whereby the displacement of the piezoelectric element 60 included in the discharge section 600 to which the drive waveform Cdp is supplied and the internal volume of the cavity 631 fall into the state where the latch signal LAT rises.

As described above, the drive circuit 50a outputs the drive signal COMA including the drive waveform Adp that drives the piezoelectric element 60 such that a predetermined amount of the ink is discharged from the discharge section 600, the drive circuit 50b outputs the drive signal COMB including the drive waveform Bdp that drives the piezoelectric element 60 such that the ink is discharged from the discharge section 600 in an amount smaller than the predetermined amount, and the drive circuit 50c outputs the drive signal COMC including the drive waveform Cdp that drives the piezoelectric element 60 such that the ink is not discharged from the discharge section 600 and the ink in the vicinity of the opening portion of the corresponding nozzle 651 vibrates. In the following description, when the drive waveform Adp is supplied to one end of the piezoelectric element 60, the amount of the ink discharged from the corresponding discharge section 600 may be referred to as a large amount, and when the drive waveform Bdp is supplied to one end of the piezoelectric element 60, the amount of the ink discharged from the corresponding discharge section 600 may be referred to as a small amount. In addition, when the drive waveform Cdp is supplied to one end of the piezoelectric element 60, the operation of vibrating the ink in the vicinity of the nozzle opening portion of the discharge section 600 corresponding to the piezoelectric element 60 may be referred to as micro-vibration.

Here, in the liquid discharge apparatus 1 of the present embodiment, from the viewpoint of improving the image formation speed on the medium P, that is, improving the productivity in the liquid discharge apparatus 1, a case where the period tp in which the ink is discharged from the discharge section 600 by the drive signals COMA, COMB, and COMC is 10 μs or shorter is assumed. That is, a case where the frequencies of the drive signals COMA, COMB, and COMC output by the drive circuits 50a, 50b, and 50c and the frequency of the period tp are 100 kHz or higher is assumed. As a result, in the liquid discharge apparatus 1 of the present embodiment, improvement in the image formation speed on the medium P, that is, improvement in the productivity in the liquid discharge apparatus 1, can be achieved. That is, the frequency of the drive signal COM in the present embodiment is 100 kHz or higher.

### 3. Configuration and Operation of Selection Control Circuit and Selection Circuit

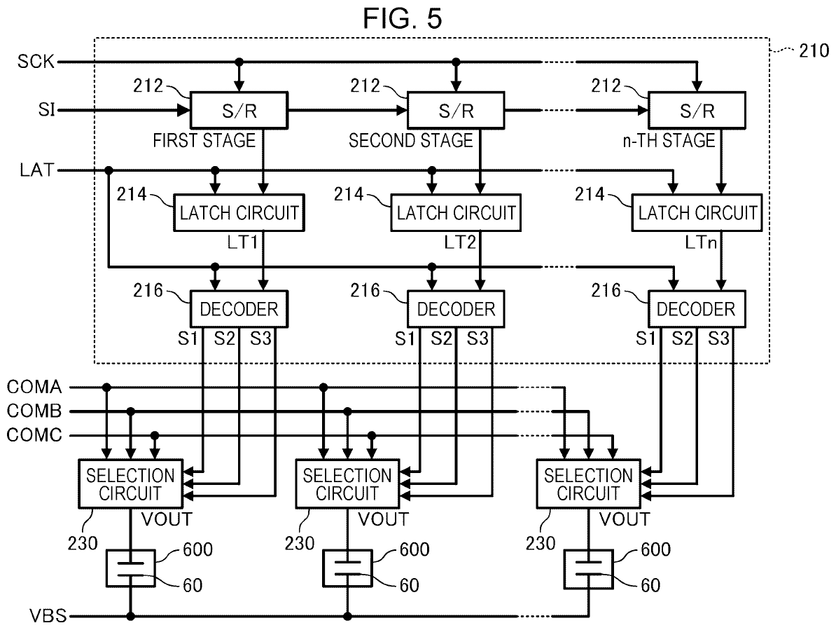

Next, the configurations and operations of the selection control circuit 210 and the selection circuit 230 that select or deselect the signal waveforms included in the drive signals COMA, COMB, and COMC, thereby generating the drive signal VOUT and outputting the generated drive signal VOUT to the corresponding discharge section 600 will be described. FIG. 5 is a diagram illustrating an example of the configuration of the selection control circuit 210 and the selection circuit 230. In the following description, the 3000 or more piezoelectric elements 60 included in the print head 20 will be described as n piezoelectric elements 60.

The clock signal SCK, the print data signal SI, and the latch signal LAT are input to the selection control circuit 210. In addition, in the selection control circuit 210, a set of a shift register (S/R) 212, a latch circuit 214, and a decoder 216 is provided corresponding to each of the n piezoelectric elements 60. That is, the selection control circuit 210 includes n shift registers 212, n latch circuits 214, and n decoders 216.

The print data signal SI is input to the selection control circuit 210 in synchronization with the clock signal SCK. In addition, the print data signal SI correspondingly includes 2-bit print data [SIH, SIL] for selecting any of “large dot LD,” “small dot SD,” “non-recording ND,” and “micro-vibration BSD” in each of the n piezoelectric elements 60 in series. The print data [SIH, SIL] included in the print data signal SI is held in the n shift registers 212 that correspond to the n piezoelectric elements 60. Specifically, the n shift registers 212 corresponding to the piezoelectric element 60 are coupled in cascade to each other, and the serially input print data signal SI is sequentially transferred to the subsequent shift register 212 according to the clock signal SCK. In addition, when the print data [SIH, SIL] is held in the corresponding shift register 212, the clock signal SCK is stopped. As a result, the print data [SIH, SIL] included in the print data signal SI is held in the corresponding shift registers 212. In FIG. 5, in order to distinguish the n shift registers 212 from each other, the shift registers 212 are denoted as a first stage, a second stage, n-th stage in order from the upstream to which the print data signal SI is input.

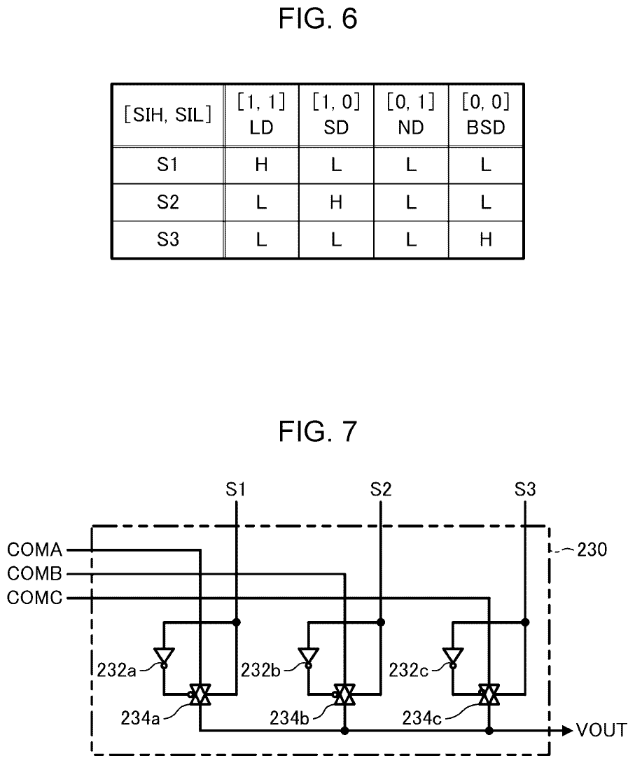

Each of the n latch circuits 214 latches the print data [SIH, SIL] held in the corresponding shift register 212 all at once at the rise of the latch signal LAT. The print data [SIH, SIL] latched by the latch circuit 214 is input to the corresponding decoder 216. FIG. 6 is a diagram illustrating an example of decoding contents in the decoder 216. The decoder 216 outputs selection signals S1, S2, and S3 as the selection signal S of a logic level that is defined by the input print data [SIH, SIL] in the period tp. For example, when the print data [SIH, SIL]=[1, 0] is input to the decoder 216, the decoder 216 outputs an L level selection signal S1, an H level selection signal S2, and an L level selection signal S3 in the period tp.

The selection signals S1, S2, and S3 output by the decoder 216 are input to the selection circuit 230. The selection circuit 230 is provided corresponding to each of the n discharge sections 600. FIG. 7 is a diagram illustrating an example of the configuration of the selection circuit 230. As illustrated in FIG. 7, the selection circuit 230 includes inverters 232a, 232b, and 232c which are NOT circuits, and transfer gates 234a, 234b, and 234c.

The selection signal S1 is input to a positive control end, which is not marked with a circle, at the transfer gate 234a, and after the logic level thereof is inverted by the inverter 232a, the selection signal S1 is input to a negative control end marked with a circle at the transfer gate 234a. The drive signal COMA is supplied to the input end of the transfer gate 234a. When the selection signal S1 at the high level is input, the transfer gate 234a is made conductive between the input end and the output end, and when the selection signal S1 at the low level is input, the transfer gate 234a is made non-conductive between the input end and the output end. That is, the transfer gate 234a outputs the drive waveform Adp included in the drive signal COMA from the output end when the logic level of the selection signal S1 is a high level, and does not output the drive waveform Adp included in the drive signal COMA from the output end when the logic level of the selection signal S1 is a low level.

The selection signal S2 is input to a positive control end, which is not marked with a circle, at the transfer gate 234b, and after the logic level thereof is inverted by the inverter 232b, the selection signal S2 is input to a negative control end marked with a circle at the transfer gate 234b. The drive signal COMB is supplied to the input end of the transfer gate 234b. When the selection signal S2 at the high level is input, the transfer gate 234b is made conductive between the input end and the output end, and when the selection signal S2 at the low level is input, the transfer gate 234b is made non-conductive between the input end and the output end. That is, the transfer gate 234b outputs the drive waveform Bdp included in the drive signal COMB from the output end when the logic level of the selection signal S2 is a high level, and does not output the drive waveform Bdp included in the drive signal COMB from the output end when the logic level of the selection signal S2 is a low level.

The selection signal S3 is input to a positive control end, which is not marked with a circle, at the transfer gate 234c, and after the logic level thereof is inverted by the inverter 232c, the selection signal S3 is input to a negative control end marked with a circle at the transfer gate 234c. In addition, the drive signal COMC is supplied to the input end of the transfer gate 234c. When the selection signal S3 at the high level is input, the transfer gate 234c is made conductive between the input end and the output end, and when the selection signal S3 at the low level is input, the transfer gate 234c is made non-conductive between the input end and the output end. That is, the transfer gate 234c outputs the drive waveform Cdp included in the drive signal COMC from the output end when the logic level of the selection signal S3 is a high level, and does not output the drive waveform Cdp included in the drive signal COMC from the output end when the logic level of the selection signal S3 is a low level.

In addition, in the selection circuit 230, the output end of the transfer gate 234a, the output end of the transfer gate 234b, and the output end of the transfer gate 234c are commonly coupled to each other. A signal at the coupling point where the output end of the transfer gate 234a, the output end of the transfer gate 234b, and the output end of the transfer gate 234c are commonly coupled is output as the drive signal VOUT.

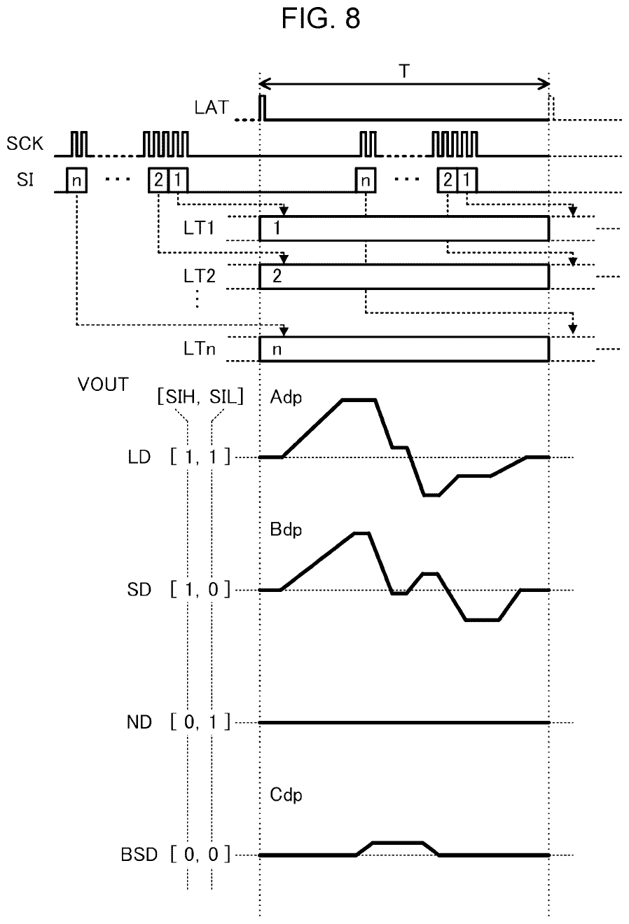

Here, the operations of the selection control circuit 210 and the selection circuit 230 will be described using FIG. 8. FIG. 8 is a diagram for describing operations of the selection control circuit 210 and the selection circuit 230. The print data signal SI is input to the selection control circuit 210 as a serial signal synchronized with the clock signal SCK, and is sequentially transferred to the n shift registers 212 corresponding to the n piezoelectric elements 60 in synchronization with the clock signal SCK. Thereafter, when the input of the clock signal SCK is stopped, the print data [SIH, SIL] that corresponds to each of the n piezoelectric elements 60 is held in the shift registers 212. The print data signal SI is input in the order corresponding to the n-th stage, . . . , the second stage, and the first stage piezoelectric elements 60 of the shift register 212.

In addition, when the latch signal LAT rises, each of the latch circuits 214 latches the print data [SIH, SIL] held in the shift register 212 all at once. LT1, LT2, . . . , LTn illustrated in FIG. 8 represent the print data [SIH, SIL] latched by the latch circuits 214 corresponding to the shift registers 212 of the first stage, the second stage, . . . , the n-th stage.

The decoder 216 outputs the selection signals S1, S2, and S3 of the logic level defined by the latched print data [SIH, SIL] every period tp. The selection circuit 230 selects or deselects the drive signals COMA, COMB, and COMC according to the logic levels of the selection signals S1, S2, and S3 output by the decoder 216, thereby generating the drive signal VOUT.

Specifically, when the print data [SIH, SIL]=[1, 1] is input to the decoder 216, the decoder 216 sets the logic levels of the selection signals S1, S2, and S3 in the period tp to H, L, and L levels. As a result, the selection circuit 230 supplies the drive signal VOUT including the drive waveform Adp to the piezoelectric element 60 included in the corresponding discharge section 600 in the period tp. As a result, a large amount of the ink is discharged from the corresponding discharge section 600. The large amount of the ink discharged from the discharge section 600 lands on the medium P, whereby the large dot LD is formed at the medium P.

In addition, when the print data [SIH, SIL]=[1, 0] is input to the decoder 216, the decoder 216 sets the logic levels of the selection signals S1, S2, and S3 in the period tp to L, H, and L levels. As a result, the selection circuit 230 supplies the drive signal VOUT including the drive waveform Bdp to the piezoelectric element 60 included in the corresponding discharge section 600 in the period tp. As a result, a small amount of the ink is discharged from the corresponding discharge section 600. The small amount of the ink discharged from the discharge section 600 lands on the medium P, whereby the small dot SD is formed at the medium P.

In addition, when the print data [SIH, SIL]=[0, 1] is input to the decoder 216, the decoder 216 sets the logic levels of the selection signals S1, S2, and S3 in the period tp to L, L, and L levels. As a result, the selection circuit 230 deselects any of the drive waveforms Adp, Bdp, and Cdp in the period tp. At this time, a signal having a constant voltage value that is held by the capacitance component of the piezoelectric element 60 is supplied to the piezoelectric element 60 included in the corresponding discharge section 600. That is, the selection circuit 230 supplies the drive signal VOUT having a constant voltage value to the piezoelectric element 60 included in the corresponding discharge section 600 in the period tp. As a result, the piezoelectric element 60 included in the corresponding discharge section 600 is not driven, and the ink is not discharged from the discharge section 600. Therefore, the ink does not land on the medium P, and the non-recording ND that does not form dots on the medium P is executed.

In addition, when the print data [SIH, SIL]=[0, 0] is input to the decoder 216, the decoder 216 sets the logic levels of the selection signals S1, S2, and S3 in the period tp to L, L, and H levels. As a result, the selection circuit 230 supplies the drive signal VOUT including the drive waveform Cdp to the piezoelectric element 60 included in the corresponding discharge section 600 in the period tp. As a result, the ink is not discharged from the corresponding discharge section 600, and the micro-vibration BSD for vibrating the ink in the vicinity of the opening portion of the nozzle 651 included in the discharge section 600 is executed.

As described above, the selection control circuit 210 and the selection circuit 230 select or deselect the signal waveforms of the drive signals COMA, COMB, and COMC output by the drive circuits 50a, 50b, and 50c, thereby generating the drive signal VOUT and outputting the generated drive signal VOUT to the piezoelectric element 60 included in the corresponding discharge section 600.

### 4. Configuration and Operation of Drive Circuit

Next, the configuration and operation of the drive circuits 50a, 50b, and 50c included in the liquid discharge apparatus 1 of the present embodiment will be described. Here, the drive circuits 50a, 50b, and 50c are different only in terms of the input signal and the output signal, and have the same configuration. Therefore, in the following description, the drive circuits 50a, 50b, and 50c will be simply referred to as the drive circuit 50 without being distinguished. At that time, in the description, a basic drive signal dO is input to the drive circuit 50 as the basic drive signals dA, dB, and dC, and the drive circuit 50 outputs the drive signal COM as the drive signals COMA, COMB, and COMC.

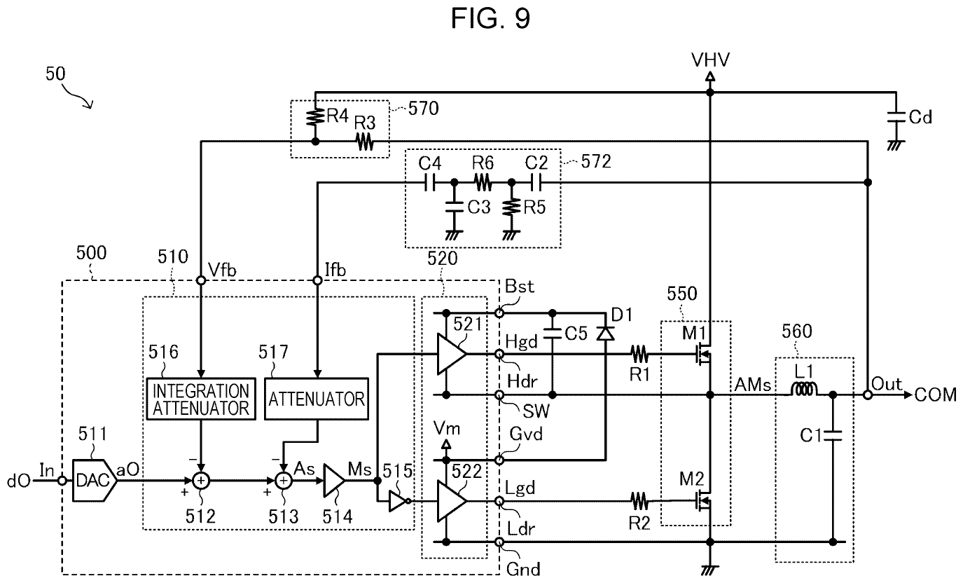

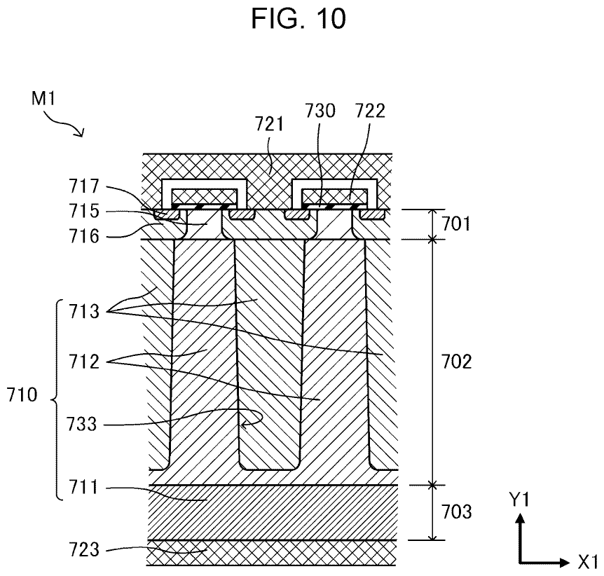

FIG. 9 is a diagram illustrating an example of the configuration of the drive circuit 50. As illustrated in FIG. 9, the drive circuit 50 includes an integrated circuit 500, an amplification circuit 550, a demodulation circuit 560, feedback circuits 570 and 572, and a plurality of other circuit elements. The integrated circuit 500 generates a gate signal Hgd and a gate signal Lgd based on the basic drive signal dO that serves as the base of the drive signal COM, and outputs the signals to the amplification circuit 550. The amplification circuit 550 includes transistors M1 and M2, and the transistors M1 and M2 are driven based on the gate signals Hgd and Lgd, whereby an amplification modulation signal AMs is generated and output to the demodulation circuit 560. The demodulation circuit 560 demodulates the amplification modulation signal AMs by smoothing the amplification modulation signal AMs. The signal demodulated by the demodulation circuit 560 is output from the drive circuit 50 as the drive signal COM.

The integrated circuit 500 has a plurality of terminals including a terminal In, a terminal Bst, a terminal Hdr, a terminal Sw, a terminal Gvd, a terminal Ldr, a terminal Gnd, a terminal Ifb, and a terminal Vfb. The integrated circuit 500 is electrically coupled to an external circuit via the plurality of terminals. In addition, the integrated circuit 500 includes a digital to analog converter (DAC) 511, a modulation circuit 510, and a gate drive circuit 520.

The DAC 511 converts the basic drive signal do, which is a digital signal that defines the signal waveform of the drive signal COM, into a basic drive signal aO, which is an analog signal, and outputs the basic drive signal aO to the modulation circuit 510. A signal obtained by amplifying the basic drive signal aO output by the DAC 511 corresponds to the drive signal COM. That is, the basic drive signal aO is a target signal before the amplification of the drive signal COM, and the basic drive signal dO is a target signal before the amplification of the drive signal COM, and is a signal that defines the shape of the signal waveform of the drive signal COM. The voltage amplitude of the basic drive signal aO output by the DAC 511 is set to, for example, 1 V to 2 V.

The modulation circuit 510 modulates the basic drive signal aO, thereby generating a modulation signal Ms and outputting the modulation signal Ms to the gate drive circuit 520. The modulation circuit 510 includes adders 512 and 513, a comparator 514, an inverter 515, an integration attenuator 516, and an attenuator 517.

The integration attenuator 516 attenuates and integrates the voltage value of the drive signal COM input via the terminal Vfb, and outputs the integrated signal to an input end on the −side of the adder 512. The basic drive signal aO is input to an input end on the +side of the adder 512. The adder 512 generates a signal having a voltage value obtained by subtracting the voltage value of the signal input to the input end on the −side from the voltage value of the signal input to the input end on the +side and integrating the results, and outputs the signal to an input end on the +side of the adder 513. Here, the maximum value of the voltage amplitude of the basic drive signal aO is approximately 2 V as described above, but the maximum value of the voltage value of the drive signal COM may exceed 40 V. In obtaining the deviation, the integration attenuator 516 attenuates the drive signal COM input via the terminal Vfb in order to match the range of the voltage amplitude of the basic drive signal aO and the range of the voltage value amplitude of the drive signal COM.

The attenuator 517 supplies a voltage obtained by attenuating the high frequency component of the drive signal COM input via a terminal Ifb to the input end on the −side of the adder 513. A signal output by the adder 512 is input to an input end on the +side of the adder 513. The adder 513 generates a voltage signal As by subtracting the voltage value of a signal input to the input end on the −side from the voltage value of the signal input to the input end on the +side, and outputs the voltage signal As to the comparator 514. The voltage signal As is a signal obtained by subtracting the voltage value of the signal supplied to the terminal Vfb from the voltage value of the basic drive signal aO and further subtracting the voltage value of the signal supplied to the terminal Ifb. Therefore, the voltage signal As becomes a signal obtained by correcting the deviation, which is obtained by subtracting the attenuation voltage of the drive signal COM from the voltage value of the target basic drive signal aO, with the high frequency component of the drive signal COM.

The comparator 514 pulse-modulates the voltage signal As and outputs the modulated voltage signal As as the modulation signal Ms. Specifically, the comparator 514 outputs the modulation signal Ms that becomes the H level when the voltage value of the voltage signal As is equal to or higher than a predetermined threshold value Vth1 in a period in which the voltage value of the voltage signal As is increasing, and becomes the L level when the voltage value of the voltage signal As falls below a predetermined threshold value Vth2 in a period in which the voltage value of the voltage signal As is decreasing. Here, the threshold values Vth1 and Vth2 are set to threshold value Vth1>threshold value Vth2. The frequency or duty ratio of the modulation signal Ms changes in accordance with the basic drive signals dO and aO. That is, the amount of change in the frequency and duty ratio of the modulation signal Ms can be adjusted by adjusting the modulation gain that corresponds to the sensitivity of the attenuator 517.

The modulation signal Ms is input to the gate driver 521 included in the gate drive circuit 520. The modulation signal Ms is also input to the gate driver 522 included in the gate drive circuit 520 after the logic level is inverted by the inverter 515. That is, signals at which the relationship between logic levels becomes mutually exclusive are input to the gate driver 521 and the gate driver 522.

Here, a timing may be controlled such that the logic levels of the signals input to the gate drivers 521 and 522 do not become the H level at the same time. That is, the above-described “relationship between logic levels becoming mutually exclusive” includes when the logic level of the signal input to the gate driver 521 and the logic level of the signal input to the gate driver 522 must not become the H level at the same time, and the logic level of the signal input to the gate driver 521 and the logic level of the signal input to the gate driver 522 become the L level at the same time.

The gate drive circuit 520 includes the gate driver 521 and the gate driver 522.

The gate driver 521 level-shifts the modulation signal Ms output by the comparator 514, thereby generating the gate signal Hgd and outputting the gate signal Hgd from the integrated circuit 500 via the terminal Hdr. Within the power supply voltages of the gate driver 521, the high potential side is supplied via the terminal Bst, and the low potential side is supplied via the terminal Sw. The terminal Bst is electrically coupled to one end of a capacitor C5 and a cathode of a diode D1. The other end of the capacitor C5 is electrically coupled to the terminal Sw. An anode of the diode D1 is electrically coupled to the terminal Gvd. In addition, the terminal Gvd is supplied with a voltage signal Vm, which is a DC voltage of, for example, 7.5 V generated by a power supply circuit (not illustrated). As a result, the potential difference between the terminal Bst and the terminal Sw is the potential difference between both ends of the capacitor C5, and becomes approximately equal to the voltage value of the voltage signal Vm. Therefore, the gate driver 521 generates the gate signal Hgd in which the voltage value of the H level is larger than the voltage value of the terminal Sw by the voltage value of the voltage signal Vm, and the voltage value of the L level becomes the voltage value of the terminal Sw, according to the logic level of the input modulation signal Ms, and outputs the gate signal Hgd from the terminal Hdr.

The gate driver 522 operates on the lower potential side than the gate driver 521. The gate driver 522 generates the gate signal Lgd by level-shifting a signal in which the logic level of the modulation signal Ms output by the comparator 514 is inverted by the inverter 515, and outputs the gate signal Lgd from the integrated circuit 500 via the terminal Ldr. Within the power supply voltages of the gate driver 522, the voltage signal Vm is supplied to the high potential side, and a ground potential is supplied to the low potential side via the terminal Gnd. In addition, the gate driver 522 generates a gate signal Lgd having a voltage value of an H level that is larger than that of the terminal Gnd by the voltage value of the voltage signal Vm and a voltage value of an L level that is the voltage value of the terminal Gnd and the ground potential according to the logic level of the input signal, and outputs the gate signal Lgd from the terminal Ldr.

Here, as described above, the gate signal Hgd is a signal obtained by level-shifting the voltage value of the modulation signal Ms, and the gate signal Lgd is a signal obtained by inverting the logic level of the modulation signal Ms and then level-shifting the voltage value of the inverted signal. In view of such a point, the gate signal Hgd and the gate signal Lgd output by the gate drive circuit 520 can also be regarded as signals obtained by modulating the basic drive signal dO and the basic drive signal aO.

The amplification circuit 550 includes a transistor pair including the transistors M1 and M2 which are semiconductor elements such as an N-type field effect transistors (FET).

A voltage signal VHV, which is, for example, a DC voltage of 42 V, is supplied to a drain terminal of the transistor M1. The voltage value of the voltage signal VHV needs only to be larger than the maximum voltage value of the drive signal COM output by the drive circuit 50, and is not limited to 42 V. The gate terminal of the transistor M1 is electrically coupled to one end of a resistor R1. The other end of the resistor R1 is electrically coupled to the terminal Hdr of the integrated circuit 500. That is, the gate signal Hgd output by the integrated circuit 500 is input to the gate terminal of the transistor M1. A source terminal of the transistor M1 is electrically coupled to the terminal Sw of the integrated circuit 500. In addition, in the transistor M1, the conduction state between the drain terminal and the source terminal is controlled by the gate signal Hgd input to the gate terminal.

A drain terminal of the transistor M2 is electrically coupled to the terminal Sw of the integrated circuit 500. That is, the drain terminal of the transistor M2 and the source terminal of the transistor M1 are electrically coupled to each other. The gate terminal of the transistor M2 is electrically coupled to one end of a resistor R2. The other end of the resistor R2 is electrically coupled to the terminal Ldr of the integrated circuit 500. That is, the gate signal Lgd output by the integrated circuit 500 is input to the gate terminal of the transistor M2. A ground potential is supplied to the source terminal of the transistor M2. In addition, in the transistor M2, the conduction state between the drain terminal and the source terminal is controlled by the gate signal Lgd input to the gate terminal.

Here, in the following description, a case where the drain terminal and the source terminal of the transistors M1 and M2 are controlled to be conductive may be referred to as on, and a case where the drain terminal and the source terminal of the transistors M1 and M2 are controlled to be non-conductive may be referred to as off.

In the amplification circuit 550 configured as described above, when the transistor M1 is controlled to be off and the transistor M2 is controlled to be on, a node to which the terminal Sw is coupled becomes a ground potential. At this time, the voltage signal Vm is supplied to the terminal Bst. On the other hand, when the transistor M1 is controlled to be on and the transistor M2 is controlled to be off, the node to which the terminal Sw is coupled becomes the voltage signal VHV. Therefore, a signal having a voltage value that is the sum of the voltage value of the voltage signal VHV and the voltage value of the voltage signal Vm is supplied to the terminal Bst. That is, the gate driver 521 that drives the transistor M1 uses the capacitor C5 as a floating power supply, and the potential of the terminal Sw at the other end of the capacitor C5 changes to the ground potential or the voltage value of the voltage signal VHV according to the operation of the transistor M1 and the transistor M2, whereby the gate driver 521 generates the gate signal Hgd in which the L level is the voltage value of the voltage signal VHV and the H level is the sum of the voltage value of the voltage signal VHV and the voltage value of the voltage signal Vm, and supplies the gate signal Hgd to the gate terminal of the transistor M1.

On the other hand, the gate driver 522 that drives the transistor M2 generates a gate signal Lgd in which the L level is the ground potential and the H level is the voltage value of the voltage signal Vm, regardless of operations of the transistor M1 and the transistor M2, and supplies the gate signal Lgd to the gate terminal of the transistor M2.

As described above, the amplification circuit 550 amplifies the modulation signal Ms obtained by modulating the basic drive signals dO and aO based on the voltage signal VHV by the transistors M1 and M2 operating in response to the gate signals Hgd and Lgd. In addition, the amplification circuit 550 outputs the amplified signal as the amplification modulation signal AMs from a coupling point where the source terminal of the transistor M1 and the drain terminal of the transistor M2 are commonly coupled.

The demodulation circuit 560 demodulates the amplification modulation signal AMs by smoothing and thereby generates the drive signal COM. In addition, the demodulation circuit 560 outputs the generated drive signal COM from the drive circuit 50.

The demodulation circuit 560 includes a coil L1 and a capacitor C1. One end of the coil L1 is electrically coupled to the source terminal of the transistor M1 and the drain terminal of the transistor M2. As a result, the amplification modulation signal AMs is input to one end of the coil L1. In addition, the other end of the coil L1 is coupled to a terminal Out that serves as the output of the drive circuit 50. In addition, the other end of the coil L1 is also coupled to one end of the capacitor C1. In addition, the ground potential is supplied to the other end of the capacitor C1. That is, the coil L1 and the capacitor C1 configure a low pass filter. In addition, the amplification modulation signal AMs is smoothed by the low pass filter configured in the demodulation circuit 560, whereby the drive signal COM is generated.

The feedback circuit 570 includes a resistor R3 and a resistor R4. One end of the resistor R3 is coupled to the terminal Out to which the drive signal COM is output, and the other end of the resistor R3 is coupled to the terminal Vfb and one end of the resistor R4. The voltage signal VHV is supplied to the other end of the resistor R4. Accordingly, the drive signal COM that has passed through the feedback circuit 570 from the terminal Out is fed back to the terminal Vfb in a pulled-up state.

The feedback circuit 572 includes capacitors C2, C3, and C4 and resistors R5 and R6. One end of the capacitor C2 is coupled to the terminal Out to which the drive signal COM is output, and the other end of the capacitor C2 is coupled to one end of the resistor R5 and one end of the resistor R6. The ground potential is supplied to the other end of the resistor R5. As a result, the capacitor C2 and the resistor R5 function as a high pass filter.

In addition, the other end of the resistor R6 is coupled to one end of the capacitor C4 and one end of the capacitor C3. The ground potential is supplied to the other end of the capacitor C3. As a result, the resistor R6 and the capacitor C3 function as a low pass filter.

As described above, the feedback circuit 572 is configured to include the high pass filter and the low pass filter. As a result, the feedback circuit 572 functions as a band pass filter that passes the drive signal COM through a predetermined frequency range. In addition, the other end of the capacitor C4 included in the feedback circuit 572 is coupled to the terminal Ifb of the integrated circuit 500. As a result, a signal in which the DC component is cut among the high frequency components of the drive signal COM that has passed through the feedback circuit 572, is fed back to the terminal Ifb, the feedback circuit 572 functioning as the band pass filter that passes a predetermined frequency component through.

Incidentally, the drive signal COM output from the terminal Out is a signal obtained by the demodulation circuit 560 smoothing the amplification modulation signal AMs to demodulate the amplification modulation signal AMs based on the basic drive signal do. In addition, the drive signal COM output by the demodulation circuit 560 is integrated and attenuated via the feedback circuit 570 and the terminal Vfb, and then fed back to the adder 512. As a result, the drive circuit 50 self-oscillates at a frequency determined by a feedback delay and a feedback transfer function. However, since the delay amount is large only in the feedback path via the terminal Vfb, the frequency of self-oscillation may not be able to increase to such an extent that the accuracy of the drive signal COM can be sufficiently secured only by feedback via the terminal Vfb.

The drive circuit 50 of the present embodiment has a path for feeding back the high frequency component of the drive signal COM via the feedback circuit 572 and the terminal Ifb, separately from the path via the terminal Vfb. As a result, in the drive circuit 50 of the present embodiment, the delay becomes small when viewed in the entire circuit configuring the drive circuit 50, and the frequency of the voltage signal As can be made high enough to sufficiently secure the accuracy of the drive signal COM, as compared with the frequency when the path via the terminal Ifb does not exist.

As described above, the drive circuit 50 of the present embodiment includes the modulation circuit 510 that outputs the modulation signal Ms obtained by modulating the basic drive signals dO and aO that serve as the base of the drive signal COM, the amplification circuit 550 that has the transistor pair including the transistor M1 and the transistor M2 and outputs the amplification modulation signal AMs obtained by amplifying the modulation signal Ms by the driving of the transistor pair, and the demodulation circuit 560 that demodulates the amplification modulation signal AMs and outputs the amplification modulation signal AMs as the drive signal COM.

Here, when the oscillation frequency of the self-oscillation of the drive circuit 50, that is, the drive frequency of the transistors M1 and M2, is increased, the switching loss generated in the transistors M1 and M2 increases, and the amount of heat generated in the transistors M1 and M2 becomes large. In addition, when the amount of heat generated in the transistors M1 and M2 becomes large, the operational stability of the drive circuit 50 including the transistors M1 and M2 decreases, and as a result, the waveform accuracy of the drive signal COM output by the drive circuit 50 decreases. In particular, as in the liquid discharge apparatus 1 of the present embodiment, when the drive circuit 50 supplies the drive signal COM having a high frequency of 100 kHz or higher to a large number of piezoelectric elements 60, that is, the 3,000 or more piezoelectric elements 60, in response to the market demand for productivity improvement, since the amount of a current flowing through the transistors M1 and M2 increases, and the drive frequency of the transistors M1 and M2 may exceed 10 MHz, the switching loss in the transistors M1 and M2 increases, as a result, the amount of heat generated in the transistors M1 and M2 significantly increases, and a concern of a decrease in the operational stability of the drive circuit 50 increases.

In response to such a problem, when the drive frequency of the transistors M1 and M2 is decreased, the switching loss in the transistors M1 and M2 can be reduced, and the amount of heat generated in the drive circuit 50 can also be reduced. However, in a configuration in which the piezoelectric element 60 is used as the drive element as in the liquid discharge apparatus 1 according to the present embodiment, from the viewpoint of controlling the discharge amount of the ink in detail, it is necessary to finely control the displacement of the piezoelectric element 60 in the period tp, and the voltage value of the drive signal thus significantly changes within a short time as illustrated in FIG. 4. As a result, when the frequency of the drive signal COM is a high frequency of 100 kHz or higher, the amount of the voltage value of the drive signal COM changed per microsecond may exceed 20 V, and the period during which the voltage value of the drive signal is held constant may be shorter than 0.3 μs. Therefore, when the drive frequency of the transistors M1 and M2 is decreased, the number of samples large enough to maintain the waveform accuracy of the drive signal COM cannot be secured, the waveform accuracy of the output drive signal COM decreases, and the discharge accuracy of the ink decreases.

That is, from the viewpoint of productivity improvement in the liquid discharge apparatus 1, when the drive circuit 50 supplies the drive signal COM having a high frequency of 100 kHz or higher to a large number of piezoelectric elements 60, that is, the 3,000 or more piezoelectric elements 60, it was difficult to reduce a concern of a decrease in the waveform accuracy of the output drive signal COM and reduce the amount of heat generated in the drive circuit 50 at the same time. In response to such a problem, in the drive circuit 50 of the present embodiment, the transistors M1 and M2 have a characteristic structure, whereby even when the drive circuit 50 supplies the drive signals COMA, COMB, and COMC having a high frequency of 100 kHz or higher to a large number of piezoelectric elements 60, that is, the 3,000 or more piezoelectric elements 60, a concern of a decrease in the waveform accuracy of the output drive signal COM can be reduced and the amount of heat generated in the drive circuit 50 is reduced at the same time.

An example of the structures of the transistor M1 and the transistor M2 will be described. Here, the transistor M1 and the transistor M2 have the same structure. Therefore, in the following description, only the structure of the transistor M1 will be described, and the description of the structure of the transistor M2 will be omitted.

FIG. 10 is a diagram illustrating an example of a structure of a transistor M1. In the description of the structure of the transistor M1, an X axis and a Y axis that are orthogonal to each other will be used. In addition, in the following description, the starting point side of the arrow of the X axis illustrated in the drawing may be referred to as −X side, and the tip side may be referred to as +X side. The starting point side of the arrow of the Y axis illustrated in the drawing may be referred to as −Y side, and the tip side may be referred to as +Y side.

As illustrated in FIG. 10, the transistor M1 includes layers 701 to 703 stacked from the +Y side to the −Y side along the Y axis, a source electrode 721, a gate electrode 722, and a drain electrode 723. In addition, the layer 701 includes an n-type semiconductor layer 715, a p-type well 716, and an n-type well 717, the layer 702 includes an n-type column layer 712 and a p-type column layer 713, and the layer 703 includes an n-type semiconductor layer 711. Here, in the following description, the n-type semiconductor layer 711 included in the layer 703, and the n-type column layer 712 and the p-type column layer 713 included in the layer 702 may be collectively referred to as a semiconductor substrate 710.

The n-type semiconductor layer 711 included in the layer 703 is an n-type semiconductor layer and is positioned on the most −Y side of the semiconductor substrate 710. The n-type column layer 712 included in the layer 702 is an n-type semiconductor layer, and the p-type column layer 713 is a p-type semiconductor layer. The n-type column layer 712 is positioned on the +Y side of the layer 703, and has a plurality of trenches 733 formed from the surface on the +Y side toward the −Y side. The p-type column layer 713 is provided in each of the plurality of trenches 733 included in the n-type column layer 712. Specifically, the n-type column layer 712 is an n-type semiconductor layer formed at the +Y side of the n-type semiconductor layer 711 included in the semiconductor substrate 710, and includes a plurality of trenches 733 arranged along the X axis. The p-type column layer 713 is a p-type semiconductor layer formed by epitaxially growing a p-type crystal in the trenches 733. That is, the n-type column layer 712 and the p-type column layer 713 are positioned on the +Y side of the n-type semiconductor layer 711 and are positioned adjacent to each other and alternately in a direction along the X axis. In other words, the semiconductor substrate 710 includes a plurality of the n-type column layers 712 and a plurality of the p-type column layers 713, and the plurality of n-type column layers 712 and the plurality of p-type column layers 713 are alternately disposed in the direction along the X axis, whereby a column region is formed in the semiconductor substrate 710.

The n-type semiconductor layer 715 included in the layer 701 is an n-type semiconductor layer and is positioned on the +Y side of the layer 702. The n-type semiconductor layer 715 is formed at the +Y side of the semiconductor substrate 710 by, for example, epitaxial growth or the like. The p-type well 716 is a diffusion layer formed by doping the n-type semiconductor layer 715 with an impurity. Specifically, the p-type well 716 is a p-type diffusion layer formed to reach the p-type column layer 713 from the surface layer portion of the n-type semiconductor layer 715 on the +Y side, and the plurality of p-type wells 716 corresponding to the plurality of p-type column layers 713 are formed to be separated from each other to be arranged along the X axis in the n-type semiconductor layer 715.

The n-type well 717 is an n-type diffusion layer formed at the surface layer portion of the p-type well 716 on the +Y side, and two n-type wells 717 are formed in each of the plurality of p-type wells 716 of the present embodiment to be separated from each other to be arranged along the X axis. The number of the n-type wells 717 formed in each of the p-type wells 716 is not limited to two.

Here, the impurity concentration of the n-type semiconductor layer 715 is set to be lower than the impurity concentration of the n-type column layer 712, the impurity concentration of the n-type semiconductor layer 711 and the impurity concentration of the n-type well 717 are set to be higher than the impurity concentration of the n-type column layer 712, and the impurity concentration of the p-type well 716 is set to be higher than the impurity concentration of the p-type column layer 713.

The gate electrode 722 is formed to bridge two p-type wells 716 positioned adjacent to each other along the X axis among the plurality of p-type wells 716 formed to be arranged along the X axis. Specifically, in the gate electrode 722, the end portion on the −X side is positioned to overlap the n-type well 717 included in the p-type well 716 on the −X side among the two p-type wells 716 positioned adjacent to each other along the X axis when viewed along the Y axis, and the end portion on the +X side is positioned to overlap the n-type well 717 included in the p-type well 716 on the +X side among the two p-type wells 716 positioned adjacent to each other along the X axis when viewed along the Y axis. In addition, gate insulating films 730 configured to include a silicon oxide film, a silicon nitride film, or the like are positioned between the gate electrode 722, the n-type semiconductor layer 715, the p-type well 716, and the n-type well 717.

The source electrode 721 is positioned on the +Y side of the p-type well 716, is disposed to cover the entire transistor M1, and is coupled to the n-type well 717 provided in the p-type well 716 via a contact (not illustrated). The drain electrode 723 is positioned on the −Y side of the semiconductor substrate 710 and on the −Y side of the n-type semiconductor layer 711, is disposed to cover the entire transistor M1, and is coupled to the n-type semiconductor layer 711 via a contact (not illustrated).

As described above, the transistor M1 includes the layer 702 including the n-type column layer 712 having the trenches 733 and the p-type column layer 713 provided in the trenches 733, the gate electrode 722 and the source electrode 721 positioned on the +Y side, which is one side of the layer 702 in the direction along the Y axis, the drain electrode 723 positioned on the −Y side, which is the other side of the layer 702 in the direction along the Y axis, the n-type semiconductor layer 715, the p-type well 716 provided in the n-type semiconductor layer 715, and the n-type well 717 provided in the p-type well 716, and includes the layer 701 which is at least partially positioned between the layer 702 and the source electrode 721 in the direction along the Y axis, and the layer 703 which is at least partially positioned between the layer 702 and the drain electrode 723 in the direction along the Y axis and includes the n-type semiconductor layer 711.

In other words, the transistor M1 includes the source electrode 721 that functions as a source terminal, the gate electrode 722 that functions as a gate terminal, the drain electrode 723 that functions as a drain terminal, the layer 702 including the n-type column layer 712 having the trenches 733 and the p-type column layer 713 provided in the trenches 733, and the layer 701 including the n-type semiconductor layer 715, the p-type well 716 provided in the n-type semiconductor layer 715, and the n-type well 717 provided in the p-type well 716, the layer 702 is disposed above the drain electrode 723, the layer 701 is disposed above the layer 702, the source electrode 721 is disposed above the p-type well 716, the gate electrode 722 is disposed above the n-type well 717, the transistor M1 further includes the layer 703 including the n-type semiconductor layer 711, and the layer 703 is disposed between the drain electrode 723 and the layer 702. Here, the fact that “a configuration B is disposed above a configuration A” means that the configuration B is positioned at least on the +Y side of the configuration A. That is, the fact that “the configuration B is disposed above the configuration A” means that the configuration B may be positioned on and adjacent to the configuration A along the Y axis, or a different configuration may be provided between the configuration A and the configuration B along the Y axis.

In the transistor M1 configured as described above, when a positive voltage is supplied to the drain electrode 723 so that the potential on the drain side becomes positive with respect to the potential on the source side, the depletion layer spreads in the direction along the X axis in the column region in which the plurality of n-type column layers 712 and the plurality of p-type column layers 713 are alternately positioned in the direction along the X axis. At this time, since the distance between the n-type column layer 712 and the p-type column layer 713 is small, when the impurity concentration of the n-type column layer 712 is somewhat low, the depletion layer spreading along the X axis comes into contact with the n-type column layer 712 in the column region, whereby the column region can be put into a depleted state. As a result, the limit strength distribution in the direction along the Y axis of the column region becomes uniform, and the withstand voltage performance of the transistor M1 improves.

In addition, in the transistor M1 of the present embodiment, when the impurity concentration of the n-type column layer 712 is somewhat low, since the withstand voltage performance can be improved, the impurity concentration of the n-type column layer 712 can be increased as compared with that of an N-type FET of a structure in the related art, and the thickness can be reduced. As a result, the on-resistance can be reduced, and the high withstand voltage of the transistor M1 is maintained at the same time.

In addition, in the transistor M2 having the same configuration as well, the on-resistance can be reduced, and the high withstand voltage is maintained at the same time.

Here, the control unit 10 and the drive circuit 50 included in the control unit 10 are an example of the print head drive circuit, at least one of the basic drive signals dO and aO is an example of the basic drive signal, one of the transistors M1 and M2 is an example of the first transistor, and the other of the transistors M1 and M2 is an example of the second transistor. In addition, the n-type is an example of the first conductive type, the p-type is an example of the second conductive type, the layer 702 is an example of the first layer, the layer 701 is an example of the second layer, the layer 703 is an example the third layer, the n-type column layer 712 is an example of the first semiconductor region, the p-type column layer 713 is an example of the second semiconductor region, the n-type semiconductor layer 715 is an example of the third semiconductor region, the p-type well 716 is an example of the fourth semiconductor region, the n-type well 717 is an example of the fifth semiconductor region, and the n-type semiconductor layer 711 is an example of the sixth semiconductor region. In addition, the source electrode 721 is an example of the first conductor, the gate electrode 722 is an example of the second conductor, and the drain electrode 723 is an example of the third conductor.

### 5. Operational Effect

In the liquid discharge apparatus 1 of the present embodiment configured as described above, when the drive circuit 50 included in the control unit 10 includes the modulation circuit 510 that outputs the modulation signal Ms obtained by modulating the basic drive signals dO and aO that serve as the base of the drive signal COM, the amplification circuit 550 that includes the transistor pair including the transistor M1 and the transistor M2 and outputs the amplification modulation signal AMs obtained by amplifying the modulation signal Ms by the driving of the transistor pair, and the demodulation circuit 560 that demodulates the amplification modulation signal AMs and outputs the demodulated signal as the drive signal COM, the transistor M1 includes the source electrode 721 that functions as a source terminal, the gate electrode 722 that functions as a gate terminal, the drain electrode 723 that functions as a drain terminal, the layer 702 having the n-type column layer 712 having the trenches 733 and the p-type column layer 713 provided in the trenches 733, and the layer 701 having the n-type semiconductor layer 715, the p-type well 716 provided in the n-type semiconductor layer 715, and the n-type well 717 provided in the p-type well 716, the layer 702 is disposed above the drain electrode 723, the layer 701 is disposed above the layer 702, the source electrode 721 is disposed above the p-type well 716, and the gate electrode 722 is disposed above the n-type well 717, whereby the on-resistance of the transistor M1 can be reduced.

As a result, even when the amount of a current flowing through the transistor M1 included in the amplification circuit 550, that is, the amount of a current generated by the propagation of the drive signal COM output by the drive circuit 50, increases, the loss in the transistor M1 is reduced. Therefore, even when the drive circuit 50 supplies the drive signal COM to a large number of the piezoelectric elements 60, since the amount of heat generated in the transistor M1 can be reduced, and the loss in the transistor M1 is reduced, the loss in the transistor M1 is also reduced when the frequency of the drive signal COM output by the drive circuit 50 is a high frequency. As a result, in the liquid discharge apparatus 1 of the present embodiment, even when the drive circuit 50 supplies the drive signal COM having a high frequency to a large number of the piezoelectric elements 60, a concern of a decrease in the waveform accuracy of the output drive signal COM can be reduced and the amount of heat generated in the drive circuit 50 is reduced at the same time. Therefore, the productivity in the liquid discharge apparatus 1 can be improved.

At this time, the transistor M2 also has the same configuration as the transistor M1, whereby the loss in the transistor M2 is also reduced when the amount of a current that flows through the transistor M2 included in the amplification circuit 550 and is generated by the propagation of the drive signal COM output by the drive circuit 50 increases. As a result, when the drive circuit 50 supplies the drive signal COM to a large number of the piezoelectric elements 60, since the amount of heat generated in the transistor M2 can be reduced, and the loss in the transistor M2 is also reduced, the loss in the transistor M2 is also reduced when the frequency of the drive signal COM output by the drive circuit 50 is a high frequency. Therefore, even when the drive circuit 50 supplies the drive signal COM having a high frequency to a large number of the piezoelectric elements 60, a concern of a decrease in the waveform accuracy of the output drive signal COM can be further reduced, the amount of heat generated in the drive circuit 50 is reduced at the same time, and the productivity in the liquid discharge apparatus 1 can be further improved.

In addition, in the liquid discharge apparatus 1 of the present embodiment, since the drive signal COM having a high frequency can be stably supplied to a large number of the piezoelectric elements 60 included in the print head 20 by reducing the losses of the transistors M1 and M2 included in the drive circuit 50, even when the print head 20 includes the 3,000 or more piezoelectric elements 60 and the drive circuit 50 supplies the drive signal COM to the 3,000 or more piezoelectric elements 60, or the drive circuit 50 outputs the drive signal COM having a frequency of 100 kHz or higher, and the drive circuit 50 includes a period in which the voltage value of the output drive signal COM changes by 20 V or more per microsecond, or the drive signal COM includes a period of shorter than 0.3 μs in which the voltage value is constant, the drive circuit 50 enables the drive signal COM having a high frequency of 100 kHz or higher to be stably supplied to the 3,000 or more piezoelectric elements 60 included in the print head 20. As a result, the productivity of the liquid discharge apparatus 1 can be enhanced.

Hitherto, the embodiments and the modification examples have been described. However, the present disclosure is not limited to the embodiments, and can be implemented in various aspects within the scope not departing from the concept of the present disclosure. For example, the above-described embodiments can also be appropriately combined with each other.

The present disclosure includes substantially the same configurations (for example, configurations having the same functions, methods, and results, or configurations having the same objects and effects) as the configurations described in the embodiments. In addition, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. In addition, the present disclosure includes configurations in which a known technology is added to the configurations described in the embodiments.

The following contents are derived from the above-described embodiments.

An aspect of a liquid discharge apparatus includes a print head that discharges a liquid in response to a drive signal; and a print head drive circuit that outputs the drive signal, in which the print head drive circuit includes a modulation circuit that outputs a modulation signal obtained by modulating a basic drive signal that serves as a base of the drive signal, an amplification circuit that outputs an amplification modulation signal obtained by amplifying the modulation signal with a first transistor and a second transistor, and a demodulation circuit that demodulates the amplification modulation signal and outputs the demodulated signal as the drive signal, the first transistor includes a first conductor that functions as a source electrode, a second conductor that functions as a gate electrode, a third conductor that functions as a drain electrode, a first layer that includes a first semiconductor region of a first conductive type having a trench and a second semiconductor region of a second conductive type provided in the trench, and a second layer that includes a third semiconductor region of the first conductive type, a fourth semiconductor region of the second conductive type provided in the third semiconductor region, and a fifth semiconductor region of the first conductive type provided in the fourth semiconductor region, the first layer is disposed above the third conductor, the second layer is disposed above the first layer, the first conductor is disposed above the fourth semiconductor region, and the second conductor is disposed above the fifth semiconductor region.

In the liquid discharge apparatus, when the print head drive circuit includes the modulation circuit that outputs a modulation signal obtained by modulating a basic drive signal that serves as the base of a drive signal, the amplification circuit that has the transistor pair including the first transistor and the second transistor and outputs an amplification modulation signal obtained by amplifying the modulation signal by the driving of the transistor pair, and the demodulation circuit that demodulates the amplification modulation signal and outputs the demodulated signal as the drive signal, the first transistor includes a first conductor that functions as a source electrode, a second conductor that functions as a gate electrode, a third conductor that functions as a drain electrode, the first layer that has the first semiconductor region of the first conductive type having the trenches and the second semiconductor region of the second conductive type provided in the trenches, and the second layer that includes the third semiconductor region of the first conductive type, the fourth semiconductor region of the second conductive type provided in the third semiconductor region, and the fifth semiconductor region of the first conductive type provided in the fourth semiconductor region, the first layer is disposed above the third conductor, the second layer is disposed above the first layer, the first conductor is disposed above the fourth semiconductor region, and the second conductor is disposed above the fifth semiconductor region, whereby the on-resistance of the first transistor can be reduced. As a result, even when the amount of a current generated by the propagation of the drive signal increases, the loss in the first transistor can be reduced.

As a result, even when the print head drive circuit supplies the drive signal to a large number of the drive elements, since the amount of heat generated in the first transistor can be reduced, and the loss in the first transistor is reduced, the loss in the first transistor is also reduced when the frequency of the drive signal output by the print head drive circuit is a high frequency. As a result, in the liquid discharge apparatus, even when the print head drive circuit supplies the drive signal having a high frequency to a large number of the drive elements, a concern of a decrease in the waveform accuracy of the output drive signal can be reduced, and the amount of heat generated in the print head drive circuit is reduced at the same time. Therefore, the productivity in the liquid discharge apparatus can be improved.

In an aspect of the liquid discharge apparatus, the impurity concentration of the third semiconductor region may be lower than the impurity concentration of the first semiconductor region, the impurity concentration of the fifth semiconductor region may be higher than the impurity concentration of the first semiconductor region, and the impurity concentration of the fourth semiconductor region may be higher than the impurity concentration of the second semiconductor region.

In an aspect of the liquid discharge apparatus, the first transistor may further include the third layer that includes the sixth semiconductor region of the first conductive type, the third layer may be disposed between the third conductor and the first layer, and the impurity concentration of the sixth semiconductor region may be higher than the impurity concentration of the first semiconductor region.

In an aspect of the liquid discharge apparatus, the print head may include 3000 or more piezoelectric elements, and the 3000 or more piezoelectric elements may be driven by the drive signal.

In the liquid discharge apparatus, even when a drive signal having a high frequency is supplied to a large number of the drive elements, since a concern of a decrease in the waveform accuracy of the output drive signal can be reduced, and the amount of heat generated in the print head drive circuit is reduced at the same time, even when the drive signal is supplied to the 3,000 or more piezoelectric elements, the stable operation of the liquid discharge apparatus and the print head drive circuit can be realized.

In an aspect of the liquid discharge apparatus, the frequency of the drive signal may be 100 kHz or higher.

In the liquid discharge apparatus, even when a drive signal having a high frequency is supplied to a large number of the drive elements, since a concern of a decrease in the waveform accuracy of the output drive signal can be reduced, and the amount of heat generated in the print head drive circuit is reduced at the same time, even when the frequency of the drive signal is 100 kHz or higher, the stable operation of the liquid discharge apparatus and the print head drive circuit can be realized.

In an aspect of the liquid discharge apparatus, the drive signal may include a period in which the voltage value changes by 20 V or more per microsecond.

In the liquid discharge apparatus, even when a drive signal having a high frequency is supplied to a large number of the drive elements, since a concern of a decrease in the waveform accuracy of the output drive signal can be reduced, and the amount of heat generated in the print head drive circuit is reduced at the same time, even when the drive signal includes a period in which the voltage value changes by 20 V or more per microsecond, the stable operation of the liquid discharge apparatus and the print head drive circuit can be realized.

In an aspect of the liquid discharge apparatus, the drive signal may include a period of shorter than 0.3 μs in which the voltage value is constant.

In the liquid discharge apparatus, even when a drive signal having a high frequency is supplied to a large number of the drive elements, since a concern of a decrease in the waveform accuracy of the output drive signal can be reduced, and the amount of heat generated in the print head drive circuit is reduced at the same time, even when the drive signal includes a period of shorter than 0.3 μs in which the voltage value is constant, the stable operation of the liquid discharge apparatus and the print head drive circuit can be realized.

An aspect of a print head drive circuit is a print head drive circuit that outputs a drive signal to a print head that discharges a liquid in response to the drive signal, the print head drive circuit including: a modulation circuit that outputs a modulation signal obtained by modulating a basic drive signal that serves as a base of the drive signal; an amplification circuit that outputs an amplification modulation signal obtained by amplifying the modulation signal with a first transistor and a second transistor; and a demodulation circuit that demodulates the amplification modulation signal and outputs the demodulated signal as the drive signal, in which the first transistor includes a first conductor that functions as a source electrode, a second conductor that functions as a gate electrode, a third conductor that functions as a drain electrode, a first layer that includes a first semiconductor region of a first conductive type having a trench and a second semiconductor region of a second conductive type provided in the trench, and a second layer that includes a third semiconductor region of the first conductive type, a fourth semiconductor region of the second conductive type provided in the third semiconductor region, and a fifth semiconductor region of the first conductive type provided in the fourth semiconductor region, the first layer is disposed above the third conductor, the second layer is disposed above the first layer, the first conductor is disposed above the fourth semiconductor region, and the second conductor is disposed above the fifth semiconductor region.

When the print head drive circuit includes the modulation circuit that outputs a modulation signal obtained by modulating a basic drive signal that serves as the base of a drive signal, the amplification circuit that has the transistor pair including the first transistor and the second transistor and outputs an amplification modulation signal obtained by amplifying the modulation signal by the driving of the transistor pair, and the demodulation circuit that demodulates the amplification modulation signal and outputs the demodulated signal as the drive signal, the first transistor includes a first conductor that functions as a source electrode, a second conductor that functions as a gate electrode, a third conductor that functions as a drain electrode, the first layer that has the first semiconductor region of the first conductive type having the trenches and the second semiconductor region of the second conductive type provided in the trenches, and the second layer that includes the third semiconductor region of the first conductive type, the fourth semiconductor region of the second conductive type provided in the third semiconductor region, and the fifth semiconductor region of the first conductive type provided in the fourth semiconductor region, the first layer is disposed above the third conductor, the second layer is disposed above the first layer, the first conductor is disposed above the fourth semiconductor region, and the second conductor is disposed above the fifth semiconductor region, whereby the on-resistance of the first transistor can be reduced. As a result, even when the amount of a current generated by the propagation of the drive signal increases, the loss in the first transistor can be reduced.

As a result, even when the print head drive circuit supplies the drive signal to a large number of the drive elements, since the amount of heat generated in the first transistor can be reduced, and the loss in the first transistor is reduced, the loss in the first transistor is also reduced when the frequency of the drive signal output by the print head drive circuit is a high frequency. As a result, even when the print head drive circuit supplies the drive signal having a high frequency to a large number of the drive elements, a concern of a decrease in the waveform accuracy of the output drive signal can be reduced, and the amount of heat generated in the print head drive circuit is reduced at the same time. Therefore, the productivity in the liquid discharge apparatus on which such a print head drive circuit is mounted can be improved.

In an aspect of the print head drive circuit, the impurity concentration of the third semiconductor region may be lower than the impurity concentration of the first semiconductor region, the impurity concentration of the fifth semiconductor region may be higher than the impurity concentration of the first semiconductor region, and the impurity concentration of the fourth semiconductor region may be higher than the impurity concentration of the second semiconductor region.

In an aspect of the print head drive circuit, the first transistor may further include the third layer that includes the sixth semiconductor region of the first conductive type, the third layer may be disposed between the third conductor and the first layer, and the impurity concentration of the sixth semiconductor region may be higher than the impurity concentration of the first semiconductor region.

In an aspect of the print head drive circuit, the print head may include 3000 or more piezoelectric elements, and the 3000 or more piezoelectric elements may be driven by the drive signal.

In the print head drive circuit, even when a drive signal having a high frequency is supplied to a large number of the drive elements, since a concern of a decrease in the waveform accuracy of the output drive signal can be reduced, and the amount of heat generated in the print head drive circuit is reduced at the same time, even when the drive signal is supplied to the 3,000 or more piezoelectric elements, the stable operation of the liquid discharge apparatus and the print head drive circuit can be realized.

In an aspect of the print head drive circuit, the frequency of the drive signal may be 100 kHz or higher.

In the print head drive circuit, even when a drive signal having a high frequency is supplied to a large number of the drive elements, since a concern of a decrease in the waveform accuracy of the output drive signal can be reduced, and the amount of heat generated in the print head drive circuit is reduced at the same time, even when the frequency of the drive signal is 100 kHz or higher, the stable operation of the liquid discharge apparatus and the print head drive circuit can be realized.

In an aspect of the print head drive circuit, the drive signal may include a period in which the voltage value changes by 20 V or more per microsecond.

In the print head drive circuit, even when a drive signal having a high frequency is supplied to a large number of the drive elements, since a concern of a decrease in the waveform accuracy of the output drive signal can be reduced, and the amount of heat generated in the print head drive circuit is reduced at the same time, even when the drive signal includes a period in which the voltage value changes by 20 V or more per microsecond, the stable operation of the liquid discharge apparatus and the print head drive circuit can be realized.

In an aspect of the print head drive circuit, the drive signal may include a period of shorter than 0.3 μs in which the voltage value is constant.

In the print head drive circuit, even when a drive signal having a high frequency is supplied to a large number of the drive elements, since a concern of a decrease in the waveform accuracy of the output drive signal can be reduced, and the amount of heat generated in the print head drive circuit is reduced at the same time, even when the drive signal includes a period of shorter than 0.3 μs in which the voltage value is constant, the stable operation of the liquid discharge apparatus and the print head drive circuit can be realized.

What is claimed is:

1. A liquid discharge apparatus comprising:
a print head that discharges a liquid in response to a drive signal; and
a print head drive circuit that outputs the drive signal, wherein
the print head drive circuit includes
a modulation circuit that outputs a modulation signal obtained by modulating a basic drive signal that serves as a base of the drive signal,
an amplification circuit that outputs an amplification modulation signal obtained by amplifying the modulation signal with a first transistor and a second transistor, and
a demodulation circuit that demodulates the amplification modulation signal and outputs the demodulated signal as the drive signal,
the first transistor includes
a first conductor that functions as a source electrode,
a second conductor that functions as a gate electrode,
a third conductor that functions as a drain electrode,
a first layer that includes a first semiconductor region of a first conductive type having a trench and a second semiconductor region of a second conductive type provided in the trench, and
a second layer that includes a third semiconductor region of the first conductive type, a fourth semiconductor region of the second conductive type provided in the third semiconductor region, and a fifth semiconductor region of the first conductive type provided in the fourth semiconductor region,
the first layer is disposed above the third conductor,
the second layer is disposed above the first layer,
the first conductor is disposed above the fourth semiconductor region, and
the second conductor is disposed above the fifth semiconductor region.

2. The liquid discharge apparatus according to claim 1, wherein
an impurity concentration of the third semiconductor region is lower than an impurity concentration of the first semiconductor region,
an impurity concentration of the fifth semiconductor region is higher than the impurity concentration of the first semiconductor region, and
an impurity concentration of the fourth semiconductor region is higher than an impurity concentration of the second semiconductor region.

3. The liquid discharge apparatus according to claim 1, wherein
the first transistor further includes a third layer that includes a sixth semiconductor region of the first conductive type,
the third layer is disposed between the third conductor and the first layer, and
an impurity concentration of the sixth semiconductor region is higher than an impurity concentration of the first semiconductor region.

4. The liquid discharge apparatus according to claim 1, wherein
the print head includes 3000 or more piezoelectric elements, and
the 3000 or more piezoelectric elements are driven by the drive signal.

5. The liquid discharge apparatus according to claim 1, wherein
a frequency of the drive signal is 100 kHz or higher.

6. The liquid discharge apparatus according to claim 1, wherein
the drive signal includes a period in which a voltage value changes by 20 V or more per microsecond.

7. The liquid discharge apparatus according to claim 1, wherein
the drive signal includes a period of shorter than 0.3 μs in which a voltage value is constant.

8. A print head drive circuit that outputs a drive signal to a print head that discharges a liquid in response to the drive signal, the print head drive circuit comprising:
a modulation circuit that outputs a modulation signal obtained by modulating a basic drive signal that serves as a base of the drive signal;
an amplification circuit that outputs an amplification modulation signal obtained by amplifying the modulation signal with a first transistor and a second transistor; and
a demodulation circuit that demodulates the amplification modulation signal and outputs the demodulated signal as the drive signal, wherein
the first transistor includes
a first conductor that functions as a source electrode,
a second conductor that functions as a gate electrode,
a third conductor that functions as a drain electrode,
a first layer that includes a first semiconductor region of a first conductive type having a trench and a second semiconductor region of a second conductive type provided in the trench, and
a second layer that includes a third semiconductor region of the first conductive type, a fourth semiconductor region of the second conductive type provided in the third semiconductor region, and a fifth semiconductor region of the first conductive type provided in the fourth semiconductor region,
the first layer is disposed above the third conductor,
the second layer is disposed above the first layer,
the first conductor is disposed above the fourth semiconductor region, and
the second conductor is disposed above the fifth semiconductor region.

9. The print head drive circuit according to claim 8, wherein
an impurity concentration of the third semiconductor region is lower than an impurity concentration of the first semiconductor region,
an impurity concentration of the fifth semiconductor region is higher than the impurity concentration of the first semiconductor region, and
an impurity concentration of the fourth semiconductor region is higher than an impurity concentration of the second semiconductor region.

10. The print head drive circuit according to claim 8, wherein
the first transistor further includes a third layer that includes a sixth semiconductor region of the first conductive type,
the third layer is disposed between the third conductor and the first layer, and
an impurity concentration of the sixth semiconductor region is higher than an impurity concentration of the first semiconductor region.

11. The print head drive circuit according to claim 8, wherein
the print head includes 3000 or more piezoelectric elements, and
the 3000 or more piezoelectric elements are driven by the drive signal.

12. The print head drive circuit according to claim 8, wherein
a frequency of the drive signal is 100 kHz or higher.

13. The print head drive circuit according to claim 8, wherein
the drive signal includes a period in which a voltage value changes by 20 V or more per microsecond.

14. The print head drive circuit according to claim 8, wherein
the drive signal includes a period of shorter than 0.3 μs in which a voltage value is constant.
